(19) United States
(12) Patent Application Publication
(10) Pub. No.: US 2012/0030556 A1
(43) Pub. Date: Feb. 2, 2012

(54) METHOD FOR ENABLING INTERACTIVE CONTENT WITHIN MESSAGING APPLICATION

(75) Inventors: Ram COHEN, Tel Aviv (IL); Aryeh MERGI, Bazra (IL)

(73) Assignee: ACTIVEPATH LTD., Petah-Tiqva (IL)

(21) Appl. No.: 12/846,029

(22) Filed: Jul. 29, 2010

(51) Int. Cl. G06F 3/14

(52) U.S. Cl. 715/221; 715/234

(57) ABSTRACT

Systems, methods and/or computer program products for presenting data to a user. In some cases, there is an additional processing of data for presentation, as some or all of the data received via a communication channel is replaced by data derived inter-alia by execution of instructions which were not executed during the original processing for presentation. Additionally or alternatively, in some cases at least some of the data transferred via a communication channel is in a form which excludes instruction(s) that could possibly be unacceptable to security module(s) and/or excludes instruction(s) that may be unsupported by a potential receiving system. In these cases, excluded instruction(s) are recovered and executed during the processing for presentation to a user. Additionally or alternatively, in some cases instead of presenting to a user received data such as content of a previously attached file, the data is stored and a reference to the stored data is presented.

### FIELD OF THE INVENTION

The present invention relates to the field of data display.

### BACKGROUND OF THE INVENTION

When transferring data including instructions via the Internet and/or any communication channel, there may sometimes exist tension between the manner of display to a destination user, for example as specified by the instructions, and characteristics of the channel and/or of the destination system. For example, security characteristics may include security module(s) such as firewalls, anti-spam software, security policies, and/or anti-virus programs, for detecting and possibly deleting potentially dangerous data. Continuing with the example and assuming that the transferred data is in Hypertext Markup Language HTML, in some cases the security module(s) may cause certain HTML elements such as scripts, interactive fields/content, forms, pointers, styles, images, objects and/or others to be removed, the transferred data to be classified as containing potentially dangerous elements, and/or the transferred data to be deleted without display to the user due to potential danger. As another example, additionally or alternatively, due to characteristics of the destination system, display in accordance with the instructions may not be fully supported or may not be supported at all. Continuing with the example, and assuming that the transferred data is in HTML, HTML data is more prone to compatibility issues than plain text. There may therefore be problems in display, especially considering the variety of available platforms and software, each of which may or may not be part of the destination system.

### SUMMARY OF THE INVENTION

According to some embodiments of the invention, there is provided a method of causing presentation of replacement data, comprising: obtaining corresponding data which corresponds to a subset of a set of data, the set of data having been received via a communication channel and processed for presentation, the corresponding data including at least one instruction; and triggering additional processing of the set of data, wherein the additional processing causes at least one of the at least one instruction to be executed in order to derive, based on the corresponding data, replacement data for presentation instead of the data subset.

According to some embodiments of the invention, there is also provided a method of obtaining corresponding data; comprising: obtaining corresponding data which corresponds to a subset of a set of data, the set of data having been received via a communication channel, the received subset of data being in a form which is acceptable to at least one security module, but the corresponding data including at least one instruction which would not have been acceptable to at least one security module; wherein replacement data is derived based on the corresponding data for presentation instead of the data subset by executing at least one of the at least one instruction.

According to some embodiments of the invention, there is further provided a method of presenting to a user content of a file previously attached to a message, comprising: receiving a message including transformed content of a previously attached file via a communication channel; inverse transforming the transformed content to recover content of the previously attached file; storing the recovered content; substituting a reference in the message for the transformed content; and when a user indicates desire to access the stored content, retrieving the content and presenting the content to the user.

According to some embodiments of the invention, there is provided a method of causing presentation of replacement data, comprising: preparing a subset of data; transferring a set of data including the subset of data via a communication channel; receiving the set of data; processing the set of data for presentation; obtaining corresponding data which corresponds to the subset, the corresponding data including at least one instruction; and triggering additional processing of the set of data, wherein the additional processing causes at least one of the at least one instruction, to be executed in order to derive, based on the corresponding data, replacement data for presentation instead of the data subset.

According to some embodiments of the invention, there is also provided a method of obtaining corresponding data; comprising: preparing a subset of data; transferring the set of data including the subset of data via a communication channel, wherein the subset is transferred in a form which is acceptable to at least one security module; receiving the set of data; obtaining corresponding data which corresponds to the subset, the corresponding data including at least one instruction which would not have been acceptable to at least one security module; and deriving replacement data based on the corresponding data for presentation instead of the data subset by executing at least one of the at least one instruction.

According to some embodiments of the invention, there is further provided a method of presenting to a user content of a file previously attached to a message, comprising: removing a file attached to a message; transforming content of the file; including the transformed content in the message; transferring the message via a communication channel; receiving the message; inverse transforming the transformed content to recover content of the previously attached file; storing the recovered content; substituting a reference in the message for the transformed content; and when a user indicates desire to access the stored content, retrieving the content and presenting the content to the user.

According to some embodiments of the invention, there is provided a system for causing presentation of replacement data, comprising: an obtainer operable to obtain corresponding data which corresponds to a subset of a set of data, the set of data having been received via a communication channel and processed for presentation, the corresponding data including at least one instruction; and a trigger activator operable to trigger additional processing of the set of data, wherein the additional processing causes at least one of the at least one instruction to be executed in order to derive, based on the corresponding data, replacement data for presentation instead of the data subset.

According to some embodiments of the invention, there is also provided a system for obtaining corresponding data; comprising: an obtainer operable to obtain corresponding data which corresponds to a subset of a set of data, the set of data having been received via a communication channel, the received subset of data being in a form which is acceptable to at least one security module, but the corresponding data including at least one instruction which would not have been acceptable to at least one security module; wherein replacement data is derived based on the corresponding data for presentation instead of the data subset by executing at least one of the at least one instruction.

According to some embodiments of the invention, there is further provided a system for presenting to a user content of a file previously attached to a message, comprising: a communicator operable to receive a message including transformed content of a previously attached file via a communication channel; an inverse transformer operable to inverse transform the transformed content to recover content of the previously attached file; and a data adjuster operable to store the recovered content, operable to substitute a reference for the transformed content, and when a user indicates desire to access the stored content, operable to retrieve the content and present the content to the user.

According to some embodiments of the invention, there is provided a computer program product comprising a computer useable medium having computer readable program code embodied therein for causing presentation of replacement data, the computer program product comprising: computer readable program code for causing the computer to obtain corresponding data which corresponds to a subset of a set of data, the set of data having been received via a communication channel and processed for presentation, the corresponding data including at least one instruction; and computer readable program code for causing the computer to trigger additional processing of the set of data, wherein the additional processing causes at least one of the at least one instruction to be executed in order to derive, based on the corresponding data, replacement data for presentation instead of the data subset.

According to some embodiments of the invention, there is also provided a computer program product comprising a computer useable medium having computer readable program code embodied therein for obtaining corresponding data; the computer program product comprising: computer readable program code for causing the computer to obtain corresponding data which corresponds to a subset of a set of data, the set of data having been received via a communication channel, the received subset of data being in a form which is acceptable to at least one security module, but the corresponding data including at least one instruction which would not have been acceptable to at least one security module; wherein replacement data is derived based on the corresponding data for presentation instead of the data subset by executing at least one of the at least one instruction.

According to some embodiments of the invention, there is further provided a computer program product comprising a computer useable medium having computer readable program code embodied therein for presenting to a user content of a file previously attached to a message, the computer program product comprising: computer readable program code for causing the computer to receive a message including transformed content of a previously attached file via a communication channel; computer readable program code for causing the computer to inverse transform the transformed content to recover content of the previously attached file; computer readable program code for causing the computer to store the recovered content; computer readable program code for causing the computer to substitute a reference in the message for the transformed content; and computer readable program code for causing the computer to retrieve the content and present the content to the user when a user indicates desire to access the stored content.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a high level block diagram of a network, according to some embodiments of the invention;

FIG. 2 is a more detailed block diagram of a recipient system, according to some embodiments of a first aspect of the invention;

FIG. 3 is a flowchart illustration of a method of causing presentation of replacement data, according to some embodiments of the first aspect of the invention;

FIG. 4 is a more detailed block diagram of a recipient system, according to some embodiments of a second aspect of the invention;

FIG. 5 is a flowchart illustration of a method of causing presentation of replacement data, according to some embodiments of the second aspect of the invention;

FIG. 6 is a more detailed block diagram of a data preparation system, according to some embodiments of the invention;

FIG. 7 is a flowchart illustration of a data preparation method, according to some embodiments of the invention;

FIG. 8 is a more detailed block diagram of a fetched data source, according to some embodiments of the invention;

FIG. 9 is an illustration of an example of a data set prior to preparation of a data subset, according to some embodiments of the invention;

FIG. 10 is an illustration of an example of the data set of FIG. 9 after preparation of the data subset, according to some embodiments of the invention;

FIG. 11 is an illustration of an example of a prepared subset, according to some embodiments of the invention;

FIG. 12 is an illustration of another example of a prepared subset, according to some embodiments of the invention; and

FIG. 13 is an illustration of an interactive button for retrieving locally stored data, according to some embodiments of the invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Some embodiments of the invention relate to systems, methods, and/or computer program products for presenting data to a user. In some of these embodiments, there is an additional processing of data for presentation, as some or all of the data received via a communication channel is replaced by data derived inter-alia by execution of instructions which were not executed during the original processing for presentation. Additionally or alternatively, in some of these embodiments data transferred via a communication channel is in a form which excludes instruction(s) that could possibly be unacceptable to security module(s) and/or excludes instruction(s) that may possibly be unsupported by a potential receiving system. In these embodiments, excluded instruction(s) are recovered and executed during the processing for presentation to a user. Additionally or alternatively, in some of these embodiments, instead of presenting to a user received data such as content of a previously attached file, the data is stored and a reference to the stored data is presented. More details on these embodiments and/or on additional embodiments, are presented below.

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

As used herein, the phrase “for example,” “such as”, “for instance” and variants thereof describe non-limiting embodiments of the present invention.

As used herein, and unless explicitly stated otherwise, the term subset is used in its usual sense, in that A is a subset of B if every element of A is also an element of B. Therefore in some cases a set may be a subset of itself.

As used herein, and unless explicitly stated otherwise, the term instruction refers to an instruction to be executed by a recipient system. The term instruction is used in its usual sense as a synonym of order, direction, command, etc.

As used herein, and unless explicitly stated otherwise, the term “memory” refers to any module for storing data for the short and/or long term, locally and/or remotely. Examples of memory include inter-alia: any type of disk including floppy disk, hard disk, optical disk, CD-ROMs, magnetic-optical disk, magnetic tape, flash memory, random access memory (RAMs), dynamic random access memory (DRAM), static random access memory (SRAM), read-only memory (ROMs), programmable read only memory PROM, electrically programmable read-only memory (EPROMs), electrically erasable and programmable read only memory (EEPROMs), magnetic card, optical card, any other type of media suitable for storing electronic instructions and capable of being coupled to a system bus, a combination of any of the above, etc

Reference in the specification to “one embodiment”, “an embodiment”, “some embodiments”, “another embodiment”, “other embodiments”, “one instance”, “some instances”, “one case”, “some cases”, “other cases” or variants thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments” one instance”, “some instances”, “one case”, “some cases”, “other cases” or variants thereof does not necessarily refer to the same embodiment(s).

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Unless specifically stated otherwise, as apparent from the following discussions, it is appreciated that throughout the specification discussions utilizing terms such as “receiving”, “determining”, “obtaining”, “triggering”, “causing”, “executing”, “allowing”, “deriving”, “using”, “transforming”, “inverse transforming”, “recognizing”, “handling”, “removing”, “stripping”, “managing”, “inserting”, “replacing”, “presenting”, “transferring”, “preparing”, “providing”, storing”, “substituting”, “retrieving”, “embedding”, or the like, refer to the action and/or processes of any combination of software, hardware and/or firmware. For example, these terms may refer in some cases to the action and/or processes of a programmable machine, that manipulates and/or transforms data represented as physical, such as electronic quantities, within the programmable machine's registers and/or memories into other data similarly represented as physical quantities within the programmable machine's memories, registers or other such information storage, transmission or display elements.

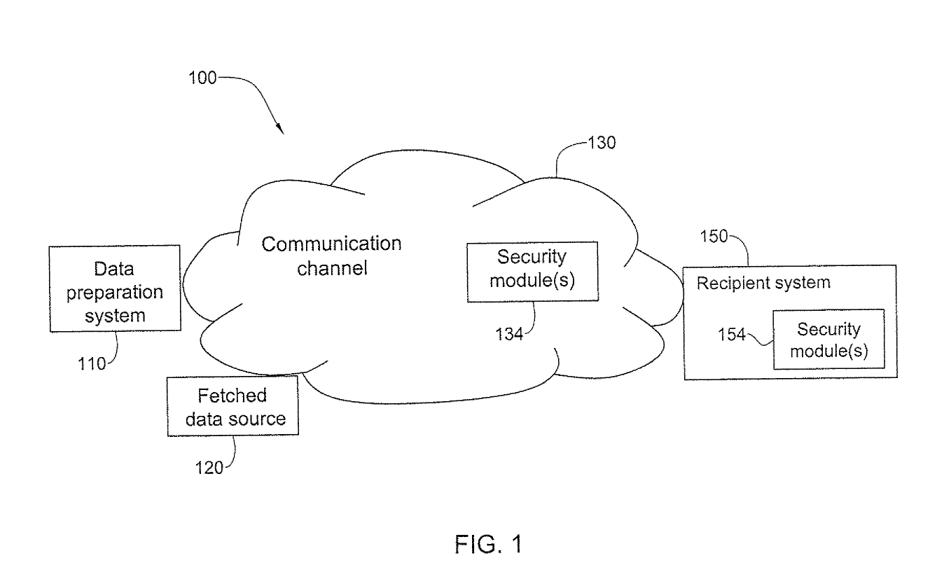

Referring now to the drawings, FIG. 1 illustrates a network 100 according to some embodiments of the invention. In the illustrated embodiments, network 100 includes one or more data preparation systems 110 configured to prepare data, one or more recipient systems 150 configured to receive data, and one or more communication channels 130. Optionally, in some embodiments, network 100 also includes one or more fetched data sources 120 configured to be the source of fetched data. Each data preparation system 110, recipient system 150 and/or fetched data source 120 may be made up of any combination of hardware, software and/or firmware capable of performing the operations as defined and explained herein. For example, in some embodiments, any of data preparation system 110, recipient system 150 and/or fetched data source 120 may comprise a machine specially constructed for the desired purposes, and/or may comprise a programmable machine selectively activated or reconfigured by specially constructed program code. For simplicity of illustration and description, a single data preparation system 110, a single recipient system 150, a single fetched data source 120, and a single communication channel 130 are illustrated in FIG. 1 and described below, but usage of the single form for any particular module of the above should be understood to include both embodiments where there is one of the particular module in network 100 and embodiments where there are a plurality of the particular module in network 100.

In some embodiments, data preparation system 110 is located at the same location as the element which originated the data that is then prepared by data preparation system 110 (for example residing on the element which originated the data or in proximity of the element which originated the data). The element which originated the data may be a user device or an element which services multiple user devices. Examples of user devices which can originate the data include personal computers, cellphones, laptops, smartphones, tablet computers, etc. Examples of elements which may service multiple user devices includes proxy servers, gateways, other types of servers, etc.

In other embodiments, data preparation system 110 is located at a different location than the element which originated the data that is then prepared by data preparation system 110, with the data transferred directly or indirectly to data preparation system 110 by the same or a different communication channel than channel 130. For example, if located at a different location, the data may in some cases be transferred in a manner which precludes filtering by any channel security module(s) for example using a cryptographic protocol such as Secure Socket Layer (SSL) or using a communication channel without channel security module(s). Continuing with the example, in some embodiments where data preparation system 110 resides at a different location than the element which originated the data, data preparation system 110 may reside anywhere in network 100 for example, on a gateway, proxy server, other type of server, on any other element servicing multiple user devices, etc. Depending on the embodiment, modules in data preparation system 110 may be concentrated in the same location, for example in one unit or in various units in proximity of one another, or modules of data preparation system 110 may be dispersed over various locations.

For simplicity of illustration, fetched data source 120 is illustrated as a separate unit from data preparation system 110 with communication between fetched data source 120 and data preparation system 110 and between fetched data source 120 and recipient system 150 via communication channel 130. However, depending on the embodiment, fetched data source 120 may be located in the same unit or in a separate unit from preparation system 110. In embodiments with separate units, the data transfer between fetched data source 120 and data preparation system 110 may be via communication channel 130 or via a different communication channel. In some cases data may be transferred between data preparation system 110 and fetched data source 120 and/or between fetched data source 120 and recipient system 150 in a manner which precludes filtering by any channel security module(s) for example using a cryptographic protocol such as SSL or using a communication channel without channel security module(s).

In embodiments where fetched data source 120 is in a separate unit than data preparation system 110, fetched data source 120 may reside anywhere in network 100, for example, on a gateway, proxy server, other type of server, any other element servicing multiple user devices, etc. Depending on the embodiment, modules in fetched data source 120 may be concentrated in the same location, for example in one unit or in various units in proximity of one another, or modules of fetched data source 120 may be dispersed over various locations.

The invention does not limit the type of recipient system 150. For example, in various embodiments recipient system 150 may include a user device such as a personal computer, cell phone, smartphone, laptop, tablet computer, etc., may include element(s) which service multiple user devices such as proxy server(s), gateway(s), other types of servers, etc, and/or may include a combination of the above. Depending on the embodiment, modules in recipient system 150 may be concentrated in the same location, for example in one unit or in various units in proximity of one another, or modules of recipient system 150 may be dispersed over various locations. In the illustrated embodiments, recipient system 150 includes security module(s) 154 such as firewalls, anti-spam software, security policies, antivirus programs, any combination of the above, etc. in order to protect recipient system 150 from potentially dangerous data. However in other embodiments, security module(s) 154 may be absent.

In some embodiments, a particular location or locations may include a recipient system such as system 150 and also (integrated or not integrated with the recipient system) a data preparation system such as system 110, an element which originates data and/or a fetched data source such as 120. In these embodiments, the functionality of the particular location(s) may in some cases vary, for example for different data. In some embodiments, additionally or alternatively, a specific location or locations may include only a recipient system such as system 150 or may include only a data preparation system such as system 110, an element which originates data and/or a fetched data source such as 120. In these embodiments, the functionality of the specific location(s) may in some cases be unvarying.

In various embodiments, communication channel 130 may comprise any suitable infrastructure for network 100 that provides direct or indirect connectivity at least between data preparation system 110 and recipient system 150. Communication channel 130 may use for example one or more wired and/or wireless technology/ies. Examples of channel 130 include cellular network channel, personal area network channel, local area network channel, wide area network channel, internetwork channel, Internet channel, any combination of the above, etc. In the illustrated embodiments, communication channel 130 includes security module(s) 134 such as firewalls, anti-spam software, security policies, anti-virus programs, any combination of the above, etc. in order to protect recipient system 150 from potentially dangerous data. However in other embodiments, security module(s) 134 may be absent. In embodiments which also include other communication channel(s) in network 100, the other communication channel(s) may comprise any suitable infrastructure for network 100, and may use one or more wired and/or wireless technologies.

In some embodiments, it is assumed that when security module(s) 134 and/or 154 filter data, security module(s) 134 and/or 154 allow data which is in an acceptable form to pass unhindered, whereas embodiments of the invention do not constrain the manner in which security module(s) 134 and/or 154 handle data which includes an unacceptable instruction. For example, in various embodiments, the unacceptable instruction may be removed, all the data may be deleted, the data may be classified as containing a potentially dangerous instruction, etc. It is noted that in some of these embodiments, a form which is acceptable to one security module may be unacceptable to another security module, and/or an instruction which is unacceptable to one security module may be acceptable to another security module.

In some embodiments of a first aspect of the invention, some or all operations of data replacement occur after an initial processing of a received data set for presentation. In these embodiments, it is assumed that a data set has been received over a communication channel, processed for presentation and possibly presented to the user. In these embodiments, corresponding data which corresponds to a subset of the data set is then obtained and the corresponding data includes one or more instructions. One or more of these instructions are executed during additional processing of the data set so as to derive replacement data. The replacement data is presented instead of the data subset. In some of these embodiments, the data subset was transferred via the communication channel in a form which is acceptable to firewalls and/or other security module(s) as well as compatible with most or all recipient systems whereas the obtained corresponding data includes one or more instructions not necessarily acceptable and compatible.

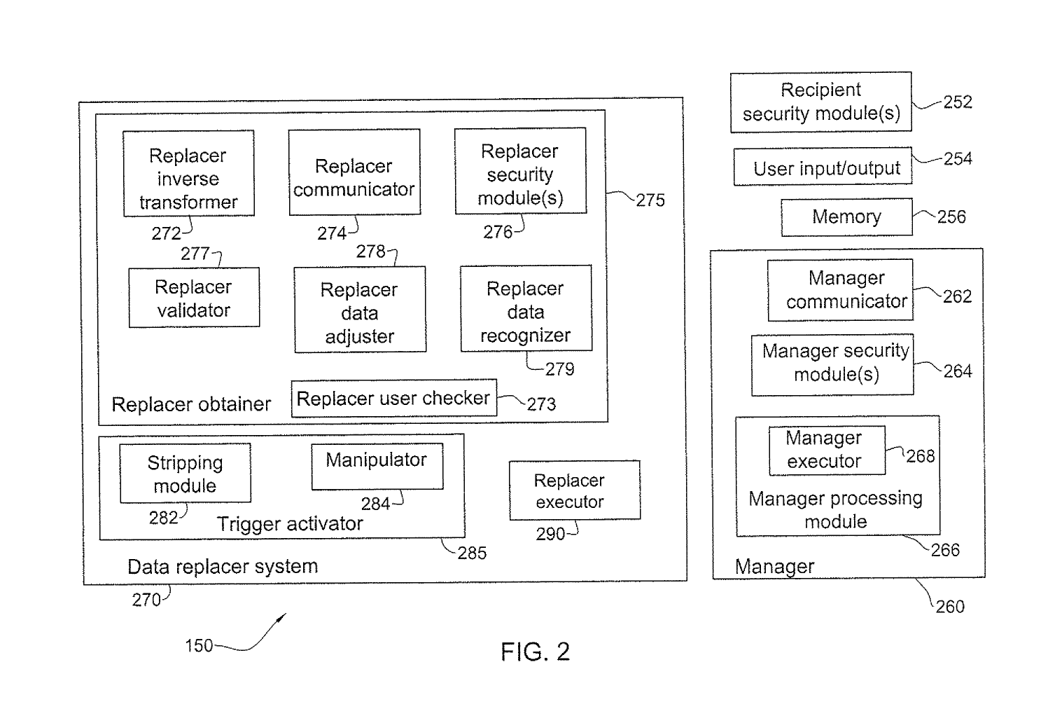

FIG. 2 is a block diagram of recipient system 150, according to some embodiments of this first aspect of the invention. In the illustrated embodiments, recipient system 150 includes a manager module 260 configured to manage data, a data replacer system 270 configured to replace data, a memory 256 configured to store data, and a user input/output 254 configured to receive data from a user of recipient system 150 and/or present data to a user of recipient system 150. Optionally, system 150 may also include recipient security module(s) 252, external to manager 260 and data replacer system 270, configured to protect recipient system 150 from potentially dangerous data. In various embodiments, each of memory 256, manager 260, data replacer system 270, recipient security module(s) 252 and/or user input/output 254 may be made up of any combination of hardware, software and/or firmware capable of performing the operations as defined and explained herein. Examples of manager 260 include: web browser, email client, instant messaging client, peer-to-peer application, user interface, SMS application, other type of Internet client, any other suitable element servicing one user device, gateway, proxy server, other type of server and/or any other suitable element servicing multiple user devices, etc. Examples of user input/output 254 include keyboard, mouse, keypad, touch-screen display, microphone, speaker, non-touch-screen display, and/or printer, etc. Examples of data replacement system 270 include: applet, toolbar, plug-in or add-on to manager 260, a standalone element associated with one user device, a gateway, a proxy server, any other type of server and/or any other standalone element servicing multiple user devices and/or an element with any other suitable configuration.

In some embodiments, recipient system 150 may comprise fewer, more, and/or different modules than those shown in FIG. 2. In some embodiments, the functionality of recipient system 150 described herein may be divided differently among the modules of FIG. 2. In some embodiments, the functionality of recipient system 150 described herein may be divided into fewer, more and/or different modules than shown in FIG. 2 and/or recipient system 150 may include additional, less and/or different functionality than described herein. Depending on the embodiment modules in recipient system 150 may be concentrated in one unit or separated among two or more units. For example, recipient system 150 may include an embedded display or a detached display when input/output 254 includes a display.

In the illustrated embodiments, manager 260 includes a manager communicator 262 configured to communicate via channel 130 and/or via another channel in network 100, optionally one or more manager security modules 264 configured to protect recipient system 150 from potentially dangerous data, and a manager processing module 266 configured to process data for presentation. In the illustrated embodiments, manager processing module 266 includes a manager executor 268 for executing instructions (if any) during processing.

In the illustrated embodiments, data replacer system 270 includes a replacer obtainer 275 configured to obtain corresponding data which corresponds to a subset of a set of data received via channel 130, a trigger activator 285 configured to trigger additional processing of the set of data leading to display of replacement data instead of the subset, and optionally a replacer executor 290 configured to execute instructions (if any).

In the illustrated embodiments, replacer obtainer 275 includes: a replacer inverse transformer 272 configured to inverse transform data and/or a replacer communicator 274 configured to communicate via channel 130 and/or via another channel in network 100. Optionally replacer obtainer 275 also includes one or more replacer security module(s) 276 configured to protect recipient system 150 from potentially dangerous data, a replacer validator 277 configured to validate data, a replacer user checker 273 configured to check whether or not user requirement(s) are fulfilled, a replacer data adjuster 278 configured to adjust data, and/or a replacer data recognizer 279 configured to recognize data.

In the illustrated embodiments, trigger activator 285 includes stripping module 282 configured to strip off instruction(s), and/or a manipulator 284 configured to manipulate data in memory 256.

Each of the modules in data replacer system 270 and manager 260 may be made up of any combination of software, hardware and/or firmware capable of performing the operations as defined and explained herein. In some embodiments, each of data replacer system 270 and manager 260 may comprise fewer, more, and/or different modules than those shown in FIG. 2. In some embodiments, the functionality of each of data replacer system 270 and manager 260 described herein may be divided differently among the modules of FIG. 2. In some embodiments, the functionality of each of data replacer system 270 and manager 260 described herein may be divided into fewer, more and/or different modules than shown in FIG. 2 and/or each of data replacer system 270 and manager 260 may include additional, less and/or different functionality than described herein. For example, replacer obtainer 275 may include other module(s) for obtaining data corresponding to the data subset in addition to or instead of one or more of the modules illustrated in FIG. 2. As another example, additionally or alternatively, manager 260 may include other module(s) for managing data in addition to or instead of one or more of the modules illustrated in FIG. 2. In another example, additionally or alternatively, trigger activator 285 may include other module(s) for triggering additional processing of the data set in addition to or instead of one or more of the modules illustrated in FIG. 2.

In various embodiments with security module(s) 154 (see FIG. 1), in this first aspect security module(s) 154 may comprise replacer security module(s) 276 in data replacer system 270, manager security module(s) 264 in manager 260 and/or recipient security module(s) 252 external to manager 260 and data replacer system 270. Examples of any of security module(s) 252, 264, and/or 276 include: firewalls, anti-spam software, security policies, anti-virus programs, any combination of the above, etc.

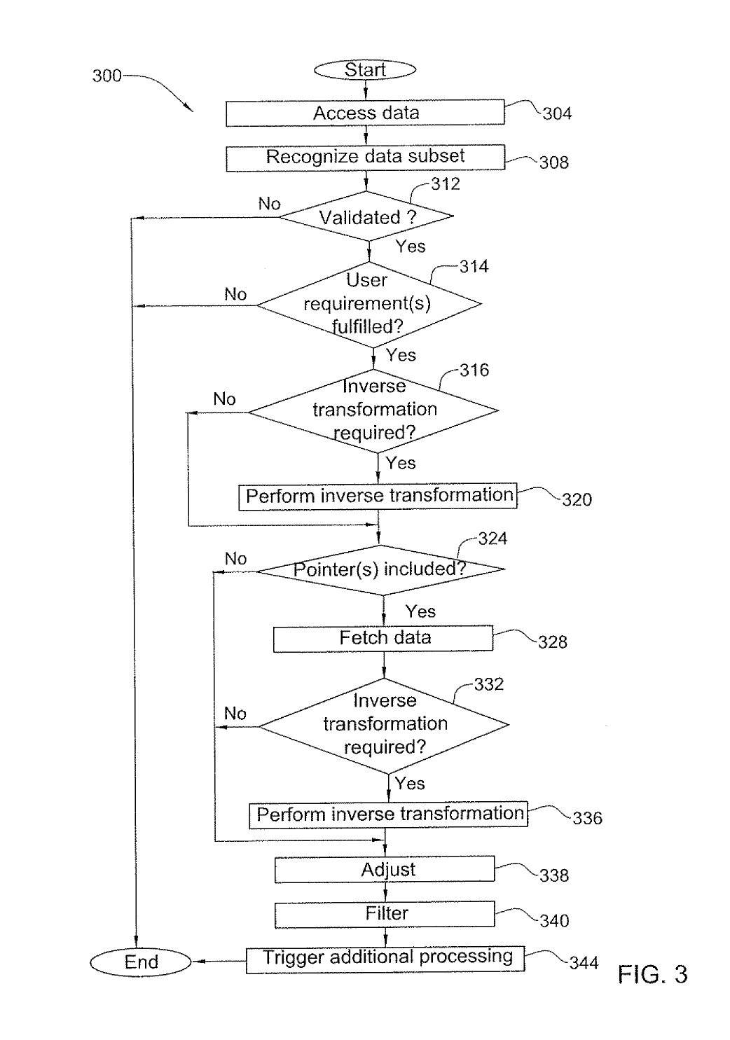

FIG. 3 is a flowchart of a method 300 of causing presentation of replacement data, according to some embodiments of the first aspect of the invention. Method 300 is performed in some embodiments by data replacer system 270. In some cases, method 300 may include fewer, more and/or different stages than illustrated in FIG. 3, the stages may be executed in a different order than shown in FIG. 3, and/or stages that are illustrated as being executed sequentially may be executed in parallel.

It is assumed that a set of data has been received via channel 130 by manager 260, for example by manager communicator 262. The set of data which has been received includes at least a data subset which is to be replaced. For example, the data subset may have been prepared earlier by data preparation system 110. For simplicity of description, it is assumed that there is at most one data subset that is to be replaced, however similar methods and systems to those described herein may be used if there are multiple subsets, mutatis mutandis. In some embodiments, the data subset was transferred via channel 130 in a form which excludes any data which could possibly be unacceptable to channel security module(s) 134, recipient security module(s) 252 and/or manager security module(s) 264. In some embodiments, additionally or alternatively, the data subset excludes any data which could possibly be unsupported by an available receiving system which could potentially be used by a user to receive the data (for example an available receiving system without replacer system 270). In some embodiments, the data subset is in the form of plain text or in the form of HTML (excluding elements which may possibly be unacceptable to security module(s) and/or unsupported by potential receiving system(s)), but in other embodiments the form can be any other suitable form.

Depending on the embodiment, upon receipt by recipient system 150 the data set including at least the data subset may or may not be filtered, for example by manager security module(s) 264 and/or recipient security module(s) 252.

It is assumed in the illustrated embodiments that the set of data including at least the data subset is processed by manager 260 for presentation, for example processed by manager processing module 266. Depending on the embodiment, the data subset may be minimally processed or may be intensely processed for presentation. The boundary between minimal and intense processing may in some cases be determined based on whether or not there are instructions embedded (i.e. included) in the data subset which are executed, for instance by manager executor 268. Instructions are assumed to necessitate intense processing. For example, assuming that the data subset is in the form of plain text, the processing may be minimal.

In some embodiments, the processing for presentation by manager 260, for example by manager processing module 266, includes parsing the data set into a document object model or similar model stored for example in memory 256.

Depending on the embodiment, after processing for presentation, the data set may or may not be presented to the user via user input/output 254. For example, in some embodiments, any data which has been processed for presentation may routinely be presented. As another example, manager 260 may recognize the data subset and cause the data subset to not be presented but other data in the set, if any, may be presented. As another example, manager 260 may cause at least the data subset to be presented in order to receive user approval (see stage 314 below).

In the illustrated embodiments, in stage 304, data replacer system 270, for example replacer data recognizer 279, accesses the data set which has been processed for presentation. For example, in some cases, replacer data recognizer 279 may obtain access to a document object model or similar model, to which manager 260, for instance manager processing module 266, parsed the data set.

In the illustrated embodiments in stage 308, data replacer system 270, for example replacer data recognizer module 279 recognizes the data subset as being a subset which is to be replaced. For example in some embodiments, the data subset may include one or more tag(s) so as to be recognized, for instance a beginning and/or end tag(s), or tag(s) around part of the data subset which would not otherwise be recognizable as targeted for replacement. The type of tagging is not limited by the invention and may be any suitable tagging. As another example, in some cases it may be known a-priori that the data subset to be replaced includes all the data set, or a predetermined part of the data set. As another example, in some cases, it may be known a-priori or indicated in the data set that the data subset to be replaced is an attached file.

In the illustrated embodiments, in optional stage 312, data replacer system 270, for example replacer validator 277 determines whether or not to validate the data. For example validation requirements may include data replacer system 270, for instance replacer validator 277, performing any of the following on validation associated items: checking the internal integrity of the data subset and/or data set, checking a message authentication code of the data set and/or data subset, checking a hash of the data set and/or data subset, checking a digital signature of the data subset and/or data set, checking the certificate with which the data subset and/or data set was signed, checking for a specific location (e.g. uniform resource locator URL) and accessing information at a remote location via the URL in order to perform validation, and/or any other validation procedure.

Depending on the embodiment of stage 312, validation item(s) and/or requirement(s) may be included in the data subset, may be included elsewhere in the data set, and/or may be known to replacer validator 277 without being included in the data set, for example based on predetermined practice, retrieval from memory 256 and/or on-the-fly generation. In embodiments where at least some validation item(s) and/or requirement(s) are included in the data subset and displayed to the user and where the data subset includes tags, validation requirement(s)/item(s) may have been displayed between tags, outside the tags and/or comprised within one or more tags. Additionally or alternatively, in embodiments where at least some validation items) and/or requirement(s) are included in the data subset and/or elsewhere in the data set and displayed to the user, some or all of the displayed validation item(s)/requirement(s) may possibly be displayed in a concealed manner which replacer validator 277 is configured to reveal.

In the illustrated embodiments with optional stage 312, if validation fails (no to stage 312), then method 300 ends. Otherwise, if there is validation in these embodiments (yes to stage 312), then method 300 continues with stage 314. In some other embodiments, stage 312 is omitted and there is no requirement for validation in order for method 300 to continue to stage 314.

In the illustrated embodiments in optional stage 314, data replacer system 270, for example replacer user checker 273, checks whether or not user requirement(s) are fulfilled. For example, in some embodiments user requirement(s) may include user approval where the user agrees to have the data subset replaced, and/or user authentication for instance automatically and/or through user input. Continuing with the example, in some of these embodiments where the data subset (or an allusion thereof such as the name of an attached file which is this case is the data subset) was displayed to the user via user input/output 254, the user uses input/output 254 to select and click on the displayed subset/allusion or to otherwise provide an indication of approval that the data subset be replaced, and the approval is understood by data replacer system 270, for example by replacer user checker 273. Continuing with the example, in some of these embodiments, user associated item(s) may include a question on whether or not replacement of data is approved, directions on how to provide approval and/or authentication, authentication items such as password, decryption key, user credentials, etc. Continuing with the example, authentication may be automatic, for instance by way of a remembered password or any other authentication item (where although for simplicity of description authentication is termed herein user authentication, in some cases the authentication additionally or alternatively includes authentication of recipient system 150). In another example, authentication is performed additionally or alternatively through user input, for instance a password or other authentication item.

Depending on the embodiment of stage 314, user items) and/or requirement(s) may be included in the data subset, may be included elsewhere in the data set, and/or may be known to replacer user checker 273 without being included in the data set, for example based on predetermined practice, retrieval from memory 256 and/or on-the-fly generation. In embodiments where at least some user item(s) and/or requirement(s) are included in the data subset and displayed to the user and where the data subset includes tags, user requirement(s)/item(s) may have been displayed between tags, outside the tags and/or comprised within one or more tags. Additionally or alternatively, in embodiments where at least some user item(s) and/or requirement(s) are included in the data subset and/or elsewhere in the data set and displayed to the user, some or all of the displayed user item(s)/requirement(s) may possibly be displayed in a concealed manner which replacer user checker 273 is configured to reveal.

In the illustrated embodiments with optional stage 314, if user requirement(s) are not fulfilled (no to stage 314), then method 300 ends. Otherwise, if user requirement(s) are fulfilled in these embodiments (yes to stage 314), then method 300 continues with stage 316. In some other embodiments, stage 314 is omitted and there are no user requirements in order for method 300 to continue to stage 316.

In the illustrated embodiments, in stage 316, it is determined if data in the subset was transformed by data preparation system 110 and therefore inverse transformation of data in the subset is required. For example, in some implementations, inverse transformation may always be required or never be required. In another example, the beginning and/or end tag, file name/extension of an attachment which in a particular embodiment happens to be the data subset, and/or other data in the subset, may specify whether or not inverse transformation should be performed and/or the type of inverse transformation.

If inverse transformation is required (yes to stage 316) then in the illustrated embodiments, in stage 320, data replacer system 270, for example replacer inverse transformer 272, inverse transforms some or all of the data subset, in accordance with an inverse transformation which is typically the inverse of a transformation performed on the data by data preparation system 110. If inverse transformation is not required, then in the illustrated embodiments, stage 320 is omitted.

In the illustrated embodiments, in stage 324, data replacer system 270, for example, replacer data recognizer 279 determines if there are any pointers included in the data subset which should be used at this stage to fetch data from fetched data source 120. For example, the beginning and/or end tag, file name/extension of an attachment which in a particular embodiment happens to be the data subset, and/or other data in the data subset, may specify whether or not such pointer(s) are included. As another example, replacer data recognizer 279 may be configured to recognize the format of such a pointer.

In some embodiments with included pointer(s), the data subset may include only pointer(s) (or only tag(s), pointer(s), validation requirement(s)/item(s), user requirement(s)/item(s), and/or notification(s)), whereas in other embodiments the data subset may also include other data. Additionally or alternatively, in some embodiments with included pointer(s), a pointer may only be detected after inverse transformation, whereas in other embodiments a pointer may be detected without inverse transformation. Additionally or alternatively, in some embodiments with included pointer(s), the pointer is in a format which is recognizable to replacer data recognizer 279 as a pointer but not necessarily recognizable to other elements (for example channel security module(s) 134, recipient security module(s) 252, and/or manager security module(s) 264) as a pointer. In some of these embodiments, the pointer is therefore not transformed by data preparation system 110 (and inverse transformed by data replacer system 270). However in other of these embodiments the pointer may in any event have been transformed (and inverse transformed). Although not thus limited by the invention, in some cases a pointer includes a URL or other location indication (which in some of these cases may have been previously transformed into a transformed URL or other location indication by data preparation system 110 and later inverse transformed).

If there are any pointers which should be used at this stage to fetch data from fetched data source 120 (yes to stage 324), then in the illustrated embodiments in stage 328, replacer system 270, for instance replacer communicator 274, uses the one or more pointers to fetch data from fetched data source 120. In some embodiments, the fetched data is transferred using the hypertext transfer protocol HTTP. In some embodiments, the fetched data includes at least one instruction that would not necessarily have been acceptable to channel security module(s) 134, recipient security module(s) 252 and/or manager security module(s) 264 if the instruction(s) had been transferred as part of the data set, the fetched data includes at least one instruction which is not necessarily supported by all available receiving systems (for example not necessarily supported by receiving systems without replacer system 270), and/or the fetched data includes at least one transformed instruction. If there are no pointers which should be used at this stage to fetch data from fetched data source 120 (no to stage 324) then in the illustrated embodiments method 300 skips to stage 338.

In some embodiments there may be pointer(s) (transformed and/or untransformed) in the data subset or in the fetched data that replacer system 270 does not use to fetch data prior to completing method 300. In these embodiments, data replacer system 270, for instance replacer data recognizer 279 may recognize such pointer(s) for example based on a tag or other data, pointer format and/or separate indication. For example, in some embodiments of a message which originally included one or more attachments (e.g. image, document, etc), the content of the attachment(s) may be placed at fetched data source 120 or at another location (or fetched data source 120 or the other location may be capable of generating the content on the fly). In this example, the data subset or the fetched data may include pointer(s) which point to the content of the previously attached file(s) (or pointer(s) with generic reference to a current balance). In some of these embodiments, the pointers or a function thereof are presented as replacement data to the user via input/output 254 subsequent to the execution of method 300 so that the user can access the content of the previously attached file(s).

In the illustrated embodiments, in stage 332, it is determined if some or all of the fetched data was transformed by data preparation system 110 and/or by fetched data source 120 and therefore inverse transformation of fetched data is required. For example, in some implementations, inverse transformation may always be required or never be required. Continuing with the example, assume the fetching in stage 328 was performed in a way which precluded filtering by channel security module(s) 134, for instance using a cryptographic protocol such as SSL or for instance, in embodiments where there are no recipient security module(s) 252 nor manager security module(s) 264 using a communication channel other than channel 130 which does not include channel security module(s). Then in this example, transformation and inverse transformation, in order to avoid mishandling by security module(s), may not be required (although transformation and inverse transformation may in some cases still occur for other reasons). In another example, replacer system 270 may receive a separate indication from fetched data source 120 whether or not inverse transformation should be performed on that data, or may recognize from the fetched data whether or not inverse transformation should be performed for instance based on a tag or other data in the fetched data.

If inverse transformation is required (yes to stage 332) then in the illustrated embodiments, in stage 336, data replacer system 270, for example replacer inverse transformer 272, inverse transforms some or all of the fetched data, in accordance with an inverse transformation which typically is the inverse of a transformation performed on the data by data preparation system 110 and/or fetched data source 120. If inverse transformation is not required, then in the illustrated embodiments stage 336 is omitted.

The invention does not limit the type of inverse transformation optionally performed by data replacer system 270 in stage 318 and/or 336. The inverse transformation may be any suitable inverse transformation which typically is the inverse of the transformation performed by data preparation system 110 and/or fetched data source 120. In some embodiments, the inverse transformation includes at least one of decrypting, decoding, decompressing, etc. In some embodiments, the inverse transformation recovers at least one instruction which in the recovered form would not necessarily have been acceptable to channel security module(s) 134, recipient security module(s) 252 and/or manager security module(s) 264 and/or recovers at least one instruction which in the recovered form would not necessarily have been supported by all available receiving systems (for example not necessarily supported by receiving systems without replacer system 270).

In the illustrated embodiments in optional stage 338 replacer system 270, for instance replacer data adjuster 278 further adjusts some or all of the data originally in the data subset, and/or some or all of the fetched and/or inverse transformed data. The types of adjustment are not limited by the invention but for further illustration to the reader, some examples are now presented.

In one example, replacer data adjuster 278 stores in local memory 256 and/or in a remote memory (e.g. fetched data source 120 or another location) some or all of the data originally in the data subset, and/or some or all of the fetched and/or inverse transformed data. Replacer data adjuster 278 substitutes reference(s) for the stored data. In some cases of this example a reference may be associated with a “fake” pointer where the pointer is feinted “fake” because the location indicated by the pointer is not the location where the data is stored. In some of these cases, the pointer is identifiable as fake to replacer system 270, although not necessarily to manager 260. In other cases, the reference may be associated with a “real” pointer, where the location indicated by the pointer is the location where the data is stored. The data to be stored may be recognized, for example by replacer data recognizer 279, based on a tag or other indicating data, format of the data to be stored, and/or separately received indication. The substitute reference(s) will be presented as replacement data to the user via input/output 254 subsequent to stage 344 so that the user can access the stored data. For instance, assume embodiments where the data set includes a message which previously had attached file(s) (e.g. document(s), binary data such as image(s), etc). In these embodiments, the data originally in the data subset, and/or the fetched and/or inverse transformed data may include the content of the previously attached file(s) and/or the name(s) of previously attached file(s) with filename(s) and/or filename extension(s) identifiable as relating to attachment(s). In some of these embodiments the content of each previously attached file may be stored by replacer data adjuster 278 to local memory 256 or to a remote memory for later retrieval by the user, and a reference (for instance associated with a “fake” or real pointer) may be substituted for the attachment content and/or filename. Assuming embodiments where a reference is associated with a “fake” pointer, the “fake” pointer may in some of these embodiments be a dummy URL (or other dummy location indication) reference which is identifiable as being “fake” due to an incorporated string which indicates that the URL is a dummy URL, for instance www.gmail.com/dummy_attachment/document.xls?id=1, where “dummy_attachment” indicates that the URL is a dummy URL for the content of a previously attached file. Assuming embodiments where a reference is associated with a “real” pointer, the real pointer may in some of these embodiments be a real URL or other location indication to stored data.

In another example, additionally or alternatively, some or all of the data originally in the data subset, and/or some or all of the fetched and/or inverse transformed data may be converted to a different type by replacer data adjuster 278. For instance, XML data may be converted to HTML or vice versa.

In another example, additionally or alternatively, some or all of the data originally in the data subset, and/or some or all of the fetched and/or inverse transformed data may be removed by replacer data adjuster 278 because the data is unrelated to subsequent presentation of replacement data. For instance, in various embodiments any of the following may optionally be removed: data which affects the display or function of various reply buttons, data relating to content of a replied message, data relating to configuration settings or code for data replacer system 270, data relating to tag(s), data relating to validation requirement(s)/item(s) data relating to user requirement(s)/item(s)requirement(s), and/or data relating to notification(s), etc. In some cases, the removed data is separately handled by recipient system 150.

In another example, additionally or alternatively, data which was not included in the original data subset, nor in the fetched and/or inverse transformed data may be added by replacer data adjuster 278 because the data relates to subsequent presentation of replacement data. For instance in some cases of this example new notification(s) for the user are added. In some cases of this example, additionally or alternatively, the data added by data adjuster 278 ensures that when the replacement data is presented, it will be evident that the data is replacement data. For instance, in some of these cases data adjuster 278 may insert a table with a frame and/or to insert visual start and/or end (e.g. text, image or a combination) markers (e.g. using JavaScript or an Application Programming Interface API).

In the illustrated embodiments, in optional stage 340, filtering may be handled by data replacer system 270, for example by replacer security module(s) 276. Depending on the embodiment, the filtering may only be for the changes in the data subset due to inverse transformation, fetching, and/or adjustment or may also include filtering any remaining original data in the data subset (or alternatively may also include filtering any remaining original data in the data set). In embodiments with filtering, the filtering may or may not correspond to filtering performed by channel security module(s) 134, recipient security module(s) 252, and/or manager security module(s) 264. For example, in some of these embodiments, the filtering performed by data replacer system 270 is less restrictive than filtering performed elsewhere. Continuing with the example, less restrictive may in some cases mean that some data which would have been unacceptable elsewhere is considered acceptable at stage 340, the threshold for acceptability is lower, and/or that data which includes unacceptable data is handled less strictly. Continuing with the example, in one of these embodiments the filtering in stage 340 may include dropping certain elements such as the object element (but not dropping scripts, images, interactive fields/content, forms, pointers, and style elements) and scanning using an anti-virus scanner. Depending on the embodiment, the filtering policy may be customized per data replacer system 270 or may be configured from some central location such as a server. Depending on the embodiment, replacer security module(s) 276 may handle filtering by performing the filtering or by other causing security module(s) within recipient system 150, for example manager security module(s) 264 or recipient security module(s) 252 to perform the filtering.

At this point, replacer system 270 has obtained data which corresponds to the data subset but which may or may not be identical to the data subset. For example, the corresponding data may be after adjustment and filtering, may include fetched data instead of pointer(s) which were included in the data subset, and/or may include inverse transformed data instead of transformed data, thereby differing from the data subset.

In some embodiments, prior to stage 344 there is an optional step where the obtained corresponding data is inserted into manager 260.

In the illustrated embodiments, it is desirable to ensure that in a subsequent presentation to the user via input/output 254, replacement data is presented instead of the data subset. Replacement data will be derived based on the obtained corresponding data inter-alia through execution of one or more instructions (if any) in the corresponding data. In order to cause replacement data to be presented instead of the data subset, additional processing of the data set which was previously processed for presentation by manager processing module 266 needs to be triggered by data replacer system 270, for example by trigger activator 282. If additional processing is not triggered, manager processing module 266 assumes that the processing performed after the data set was received by manager communicator 262 was sufficient.

Therefore, in the illustrated embodiments in stage 344, additional processing of the data set by manager processing module 266 is triggered by data replacer system 270, for example by trigger activator 285.

The invention does not limit the actions of triggering the additional processing. However for the sake of further illustration to the reader, some examples will now be presented.

In some embodiments, the data subset is removed by replacer system 270, for instance by data manipulator 284, so that the data subset is no longer designated for subsequent presentation to the user via input/output 254. For example, assuming that there is a document object model or similar model in memory 256 corresponding to the data set, replacer system 270 may find the lowest model element (in the document object model hierarchy or similar hierarchy) which contains the entire data subset and may erase the contents of this element, thereby removing the data subset.

In some embodiments, data is then inserted by data replacer system 270, for instance by data manipulator 284.

For example, in some of these embodiments, the corresponding data is scanned by data replacer system 270, for instance by stripping module 282, in order to find certain or all instructions (if any) in the corresponding data which if remaining in the corresponding data would not be automatically executed by manager 260. The certain or all instructions (if any) are removed (i.e. stripped) from the corresponding data. In these embodiments, replacer system 270, for instance manipulator 284, inserts the stripped corresponding data (i.e. the corresponding data minus the removed instructions). In these embodiments, replacer system 270, for instance stripping module 282, provides the stripped instructions (if any) to manager processing module 266, thereby triggering manager processing module 266 to perform additional processing of the data set. For instance in various cases, the corresponding data may be scanned for instructions such as script and/or style elements, may be scanned for instructions such as script, image, interactive field/content, pointer, form and/or style elements, or may be scanned for any one or more types of elements, and these instructions (if any) may be removed. In these cases and assuming that manager 260 is a browser, the removed instructions are added to the browser engine using the browser application programming interface API. In these cases and assuming that there is a document object model or similar model associated with the data set in memory 256, the stripped corresponding data (i.e. the corresponding data minus the stripped instructions) is then inserted. For instance, the stripped corresponding data may be inserted into the lowest model element in the document object model hierarchy or similar model hierarchy which contained the entire data subset prior to removal, somewhere else in the document object model or similar model, in a new window, etc. In some of these cases, elements included in the data subset and/or in the stripped corresponding data are provided with large arbitrary identification values so as not to conflict with any existing elements identification values in the document object model or other model. For instance a long prefix may be added to each element identifier.

Alternatively or additionally, in another example, in some of these embodiments, it is assumed that there is a document object model or similar model associated with the data set in memory 256. In this example data replacer system 270, for instance data manipulator 284, inserts an adapted “IFrame” element. In various cases, the adapted “IFrame” element may be inserted inside the lowest model element in the document object model hierarchy or similar model hierarchy which contained the entire data subset prior to removal, somewhere else in the document object model or similar model, in a new window, etc. The inserting may be performed using for example JavaScript or an API. It is noted that traditionally the “IFrame” element includes a source URL for the source of the data to show in the frame. However, in these embodiments the corresponding data is local to data replacer system 270 (for instance in memory 256) and therefore the IFrame element is adapted from traditional use. The adaption may include, in some cases, creating an IFrame element with no source. Alternatively, in some cases, the adaption may include creating an IFrame element with a source URL, for example using a “dummy” URL as described above. In these cases the URL request is captured and the data from the source URL, which may in some instances be an “error page” is removed. In this example, data replacer system 270, for instance data manipulator 284 uses JavaScript to insert the corresponding data into the adapted IFrame element. In some cases of this example, data replacer system 270, for instance data manipulator 284, inserts JavaScript code in the adapted IFrame element to adjust the IFrame dimensions within the presentation of the data set. Because usage of the IFrame element signals that the contents are new, the insertion of the IFrame element triggers manager processing module 266 to perform additional processing on the data set, namely to process the contents of the IFrame element which in this case includes the corresponding data. Furthermore, because the contents of the IFrame element are isolated from the contents of the data in which the IFrame element was inserted, there will not be conflicts between elements in the corresponding data and any existing elements identification values in the document object model or other model, such as for example due to the same JavaScript function, variable names, etc.

Alternatively or additionally, in another example, in some of these embodiments, it is assumed that there is a document object model or similar model associated with the data set in memory 256. In this example, data replacer system 270, for instance data manipulator 284, inserts a created “object” element inside the lowest model element in the document object model hierarchy or similar model hierarchy which contained the entire data subset prior to removal, somewhere else in the document object model or similar model, in a new window, etc The insertion may be performed using for example JavaScript or an API. The inserted object element may be a reference, for instance, to replacer executor 290. The insertion of an object element triggers manager processing module 266 to perform additional processing on the data set, namely to invoke the object and pass object information from inside the object tag to the invoked object. The invoked object, for instance replacer executor 290, may be for example a flash object, an alternate processor (which processes the embedded instructions differently than manager 260), etc.

In some insertion examples, cookies may also be inserted by data replacer system 270 for instance by data manipulator 284. Referring for instance to the insertion examples described above, in some embodiments one or more cookies may be provided to manager processing module 266, one or more cookies may be inserted into the IFrame element, or one or more cookies may be passed to the invoked object, respectively. Continuing with these examples, in some cases data replacer system 270 may possess an authentication token which may later be required by the user when performing an operation with a remote server. Therefore in some of these cases of these examples, an authentication cookie holding an authentication token is provided to manager processing module 266, inserted in the IFrame element, or passed to the invoked object, respectively so that any communicator such as for instance manager communicator 262, can later send the cookie to the remote server when the user performs the operation.

Once the additional processing of the data set has been triggered, the additional processing causes at least one instruction from the corresponding data (if any) to be executed in order to derive based on the corresponding data replacement data for presentation instead of the data subset. The additional processing and execution are not limited by the invention, but for further illustration to the reader a few examples are now given.

In one example, assume that the stripped instructions (if any) had been provided to manager processing module 266, and the stripped corresponding data has been inserted, for instance inserted in place of the removed data subset, inserted somewhere else in the document object model or similar model corresponding to the data set, inserted in a new window etc. In this example, the additional processing of the data set by manager processing module 266, causes the provided stripped instructions (if any) to be executed by manager executor 268 in order to derive replacement data based on the corresponding data. The replacement data is subsequently presented to the user via user input/output 254.

In another example, assume that an adapted IFrame element has been inserted as described above. In this example, the additional processing by manager processing module 266 of the data set includes processing the IFrame element contents, causing instructions (if any) in the corresponding data to be executed by manager executor 268 in order to derive replacement data based on the corresponding data. The replacement data is subsequently presented to the user via user input/output 254.

In another example, assume that an object element has been inserted as described above. In this example, the additional processing by manager processing module 266 includes invoking the object element, for example replacer executor 290, which causes instructions (if any) in the corresponding data to be executed by replacer executor 290 in order to derive replacement data based on the corresponding data. The replacement data is subsequently presented to the user via user input/output 254.

In embodiments where there are no instructions in the corresponding data, the replacement data is derived based on the corresponding data without execution of instructions, and in some cases of these embodiments the replacement data is substantially identical to the corresponding data.

In some embodiments, there is some indication to the user that replacement data is being presented instead of the data subset. For example, the replacement data may be presented in a manner which indicates that the data is replacement data, for instance the presentation may include a frame or visual markers optionally inserted by replacer data adjuster 278 as discussed above. Additionally or alternatively, in another example, a separate indication of the replacement may be provided to the user via user output 254.

In some embodiments, replacer system 270 provides an indication to data preparation system 110 and/or fetched data source 120 that replacement data was presented to the user instead of the data subset. For example, replacer communicator 274 can transfer such an indication to data preparation system 110 and/or fetched data source 120.

It is noted that the replacement data presented to the user may in some cases include reference(s) associated with data stored in local memory 256 or in a remote memory, for example reference(s) created during stage 338 as discussed above. In such cases, data replacer system 270, for instance replacer data adjuster 278, determines that access to the stored data is desired. For example a user may have indicated a desire to access the data, for instance by clicking on the reference using input/output interface 254. As another example, additionally or alternatively and assuming the reference is associated with a “fake” or “real” pointer, manager communicator 262 may have attempted to download data using the “fake” or “real” pointer. In these cases, data replacer system 270, may allow retrieval of the data from local memory 256 or a remote memory, for instance by presenting a dialog for “saving” or “opening” the data to the user via user input/output 254. As mentioned above, in some cases the reference(s) may be associated with the content of previously attached files(s) to a message.

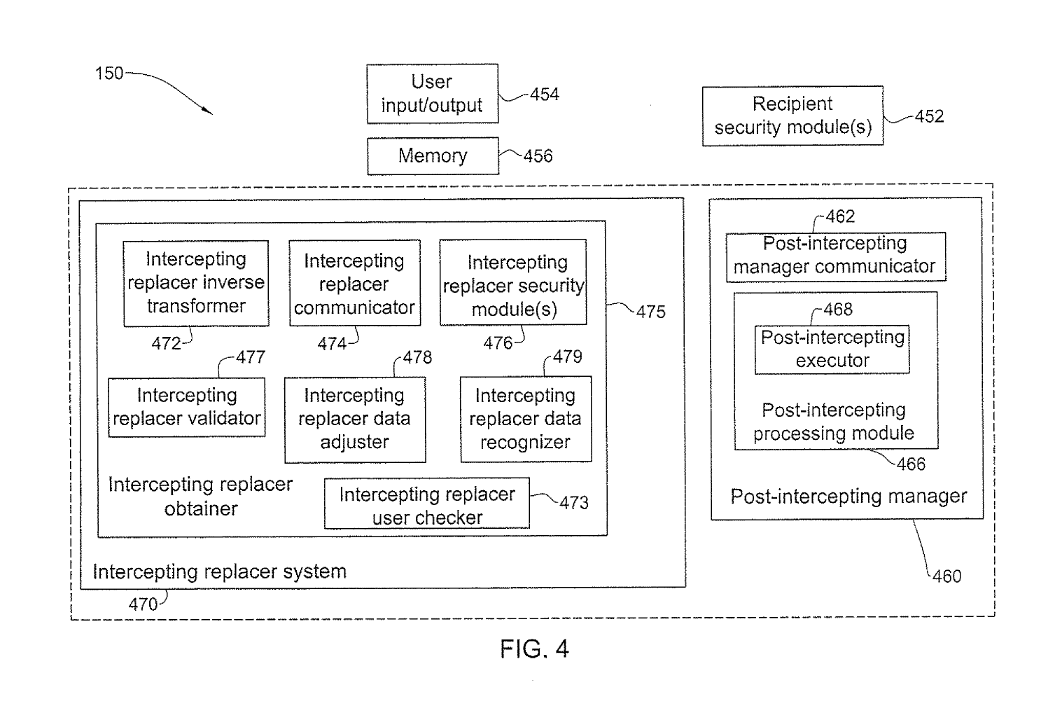

In another aspect of the invention, some or all of the operations of data replacement are performed prior to processing data for presentation. Refer to FIG. 4, which illustrates a recipient system 150 in accordance with some embodiments of this aspect of the invention. In the illustrated embodiments of this aspect, recipient system 150 includes an intercepting replacer system 470 configured to replace data, a post-intercepting manager 460 configured to manage data, a user input/output 454 configured to receive data from a user of recipient system 450 and/or present data to a user of recipient system 150, and a memory 456 configured to store data. Optionally, system 150 may also include recipient security module(s) 452, external to post-intercepting manager 460 and to intercepting replacer system 470, configured to protect recipient system 150 from potentially dangerous data. In various embodiments, each of intercepting replacer system 470, post-intercepting manager 460, recipient security module(s) 452, user input/output 454, and/or memory 456 may be made up of any combination of hardware, software and/or firmware capable of performing the operations as defined and explained herein. Examples of user input/output 254 include inter-alia keyboard, mouse, keypad, microphone, speaker, touch-screen display, non touch-screen display, and/or printer, etc.

In some embodiments, recipient system 150 in this aspect may comprise fewer, more, and/or different modules than those shown in FIG. 4. In some embodiments, the functionality of recipient system 150 described herein with respect to this aspect may be divided differently among the modules of FIG. 4. In some embodiments, the functionality of recipient system 150 described herein with respect to this aspect may be divided into fewer, more and/or different modules than shown in FIG. 4 and/or recipient system 150 may include additional, less and/or different functionality than described herein with respect to this aspect. Depending on the embodiment, modules in recipient system 150 may be concentrated in one unit or separated among two or more units. For example, recipient system 150 may include an embedded display or a detached display when input/output 454 includes a display.

Depending on the embodiment, intercepting replacer system 470 and post intercepting manager 460 may or may not be integrated together (the box surrounding intercepting replacer system 470 and post intercepting manager 460 is comprised of broken lines in order to illustrate optional integration). For example, in some embodiments intercepting replacer system 470 and post intercepting manager 460 are integrated together, for example representing a web browser, an email client, an instant messaging client, a peer to peer application, a user interface, an SMS application, another type of Internet client, any other suitable element servicing one user device, a gateway, a proxy server, another type of server, and/or any other suitable element servicing multiple user devices, etc. which includes functionality as described herein. In another example, intercepting replacer system 470 and post intercepting manager 460 are not integrated together. For instance, intercepting replacer system 470 may be an applet, toolbar, plug-in or add-on to manager 260, a standalone element associated with one user device, a gateway, a proxy server, any other type of server and/or any other standalone element servicing multiple user devices, and/or an element with any other suitable configuration. Similarly in this example, post intercepting manager 460 may be for instance a web browser, email client, instant messaging client, peer to peer application, user interface, SMS application, other type of Internet client, any other suitable element servicing one user device, gateway, proxy server, other type of server and/or any other suitable element servicing multiple user devices, etc. Continuing with this example, intercepting replacer system 470 and post intercepting manager 460 may be in some cases located at separate locations. For instance, in some of these cases intercepting replacement system 470 is located at an element servicing multiple user devices such as a gateway, etc, while post intercepting manager 460 is located at a user device. However in other cases of this example, intercepting replacer system 470 and post intercepting manager 460 may be located at the same location.

In the illustrated embodiments of this aspect, intercepting replacer system 470 includes an intercepting replacer obtainer 475 configured to obtain corresponding data which corresponds to a subset of a set of data received via channel 130. In the illustrated embodiment post-intercepting manager 460 includes a post-intercepting processing module 466 configured to process data for presentation and optionally a post-intercepting manager communicator 462 configured to communicate via channel 130 and/or via another channel in network 100 (for example post intercepting manager communicator 462 may be included in some cases when intercepting replacer system 470 and post intercepting manager 460 are not integrated together).

In the illustrated embodiments, intercepting replacer obtainer 475 includes an intercepting replacer inverse transformer 472 configured to inverse transform data and/or an intercepting replacer communicator 474 configured to communicate via channel 130 and/or via another channel in network 100. Optionally intercepting replacer obtainer 475 also includes one or more intercepting replacer security module(s) 476 configured to protect recipient system 150 from potentially dangerous data, an intercepting replacer validator 477 configured to validate data, an intercepting replacer user checker 473 configured to check whether or not user requirement(s) are fulfilled, an intercepting replacer data adjuster 478 configured to adjust data, and/or an intercepting replacer data recognizer 479 configured to recognize data.

In the illustrated embodiments, post intercepting processing module 466 includes post intercepting executor 468 configured to execute instructions (if any) during the processing.

Each of the modules in intercepting replacer system 470 and post intercepting manager 460 may be made up of any combination of software, hardware and/or firmware capable of performing the operations as defined and explained herein. In some embodiments, each of intercepting replacer system 470 and post intercepting manager 460 may comprise fewer, more, and/or different modules than those shown in FIG. 4. In some embodiments, the functionality of each of intercepting replacer system 470 and post intercepting manager 460 described herein may be divided differently among the modules of FIG. 4. In some embodiments, the functionality of each of intercepting replacer system 470 and post intercepting manager 460 described herein may be divided into fewer, more and/or different modules than shown in FIG. 4 and/or each of intercepting replacer system 470 and post intercepting manager 460 may include additional, less and/or different functionality than described herein. For example, intercepting replacer obtainer 475 may include other module(s) for obtaining data corresponding to the data subset in addition to or instead of one or more of the modules illustrated in FIG. 4. As another example, additionally or alternatively, post intercepting manager 460 may include other module(s) for managing data in addition to or instead of one or more of the modules illustrated in FIG. 4.

In various embodiments with security module(s) 154 (see FIG. 1), in this second aspect security module(s) 154 may comprise intercepting replacer security module(s) 476 in intercepting replacer system 470, and/or recipient security module(s) 452 external to post intercepting manager 460 and intercepting data replacer system 470. Examples of any of security module(s) 452 and/or 476 include: firewalls, anti-spam software, security policies, anti-virus programs, any combination of the above, etc.

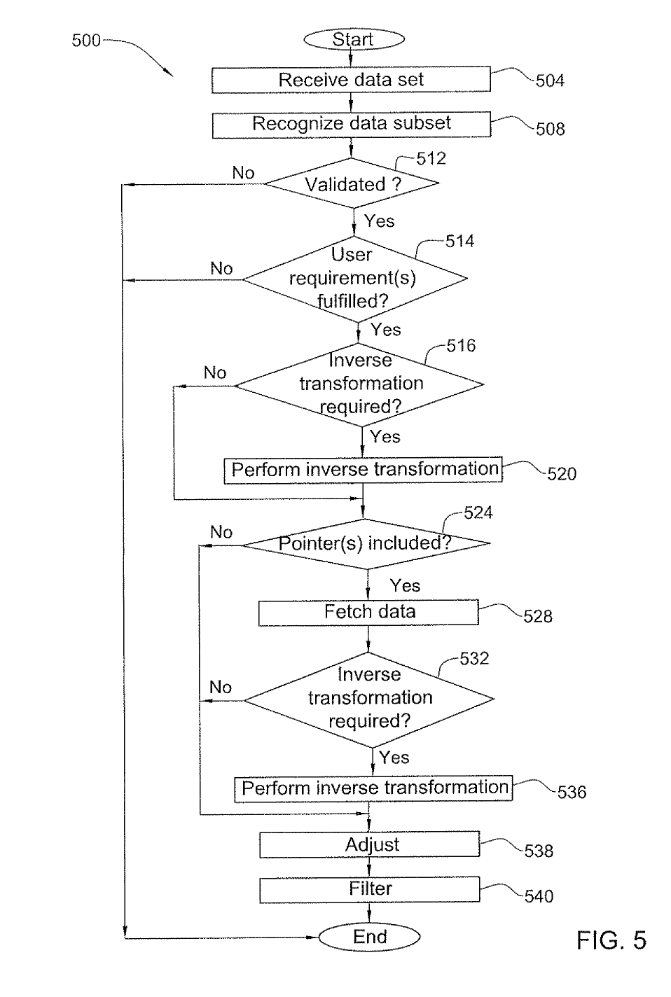

Refer to FIG. 5 which is a flowchart of a method of causing presentation of replacement data according to some embodiments of this aspect of the invention. Method 500 is performed in some embodiments by intercepting replacer system 470. In some cases, method 500 may include fewer, more and/or different stages than illustrated in FIG. 5, the stages may be executed in a different order than shown in FIG. 5, and/or stages that are illustrated as being executed sequentially may be executed in parallel.

In stage 504 a set of data is received via channel 130 by intercepting replacer 470, for example by intercepting replacer communicator 474. The set of data which is received includes at least a data subset which is to be replaced. For example, the data subset may have been prepared earlier by data preparation system 110. For simplicity of description, it is assumed that there is at most one data subset that is to be replaced, however similar methods and systems to those described herein may be used if there are multiple subsets, mutatis mutandis. In some embodiments, the data subset was transferred via channel 130 in a form which excludes any data which could possibly be unacceptable to channel security module(s) 134 and/or recipient security module(s) 452. In some embodiments, additionally or alternatively, the data subset excludes any data which could possibly be unsupported by an available receiving system which could potentially be used by a user to receive the data (for example an available receiving system without intercepting replacer 470). In some embodiments, the data subset is in the form of plain text or in the form of HTML (excluding elements which may possibly be unacceptable to security module(s) and/or unsupported by potential receiving systems), but in other embodiments the form can be any other suitable form.

Depending on the embodiment, upon receipt by recipient system 150, the data set may or may not be filtered by intercepting replacer security module(s) 476 and/or recipient security module(s) 252. For example, in some embodiments, the data set including at least the data subset may be filtered. In some other embodiments, for example, any data in the data set other than the data subset may be filtered. In some other embodiments, for example, the data set may not be filtered. In still other embodiments the filtering may be postponed until after stage 508 or until even later in method 500.

In the illustrated embodiments in stage 508, intercepting replacer system 470, for example intercepting replacer data recognizer module 279 recognizes the data subset as being a subset which is to be replaced. For example in some embodiments, the data subset may include one or more tag(s) so as to be recognized, for instance a beginning and/or end tag(s), or tag(s) around part of the data subset which would not otherwise be recognizable as targeted for replacement. As another example, in some cases it may be known a-priori that the data subset to be replaced includes all the data set, or a predetermined part of the data set. As another example, in some cases, it may be known a priori that the data subset to be replaced is an attached file.

In the illustrated embodiments, in optional stage 512, intercepting replacer system 470, for example intercepting replacer validator 477 determines whether or not to validate the data. For example, validation requirements may include intercepting replacer system 470, for instance intercepting replacer validator 477, performing any of the following: checking the internal integrity of the data subset or data set, checking a message authentication code of the data set and/or data subset, checking a hash of the data set and/or data subset, checking a digital signature of the data subset and/or data set, checking the certificate with which the data subset and/or data set was signed, checking for a specific location (e.g. URL) and accessing information at a remote location via the URL in order to perform validation, and/or any other validation procedure.

Depending on the embodiment of stage 512, validation items(s) and/or requirement(s) may be included in the data subset, may be included elsewhere in the data set and/or may be known to intercepting replacer validator 477 without being included in the data set, for example based on predetermined practice, retrieval from memory 456, and/or on-the-fly generation.

In the illustrated embodiments, with optional stage 512, if validation fails (no to stage 512), then method 500 ends. In these embodiments, post intercepting manager 460 processes the data subset along with any other data in the data set in a traditional manner for presentation to the user via input/output 454. Otherwise, if there is validation in these embodiments (yes to stage 512), then method 500 continues with stage 514. In some other embodiments, stage 512 is omitted and there is no requirement for validation in order for method 500 to continue to stage 514.

In the illustrated embodiments in optional stage 514, intercepting replacer system 470, for example, intercepting replacer user checker 473, checks whether or not user requirement(s) are fulfilled. For example, in some embodiments user requirement(s) may include user approval where the user agrees to have the data subset replaced and/or user authentication for instance automatically and/or through user input. Continuing with this example, in some of these embodiments, the user may be presented with a user-associated item such as question on whether replacement of data is approved and the user may provide an indication of approval that the data subset be replaced via user input/output 454. In other embodiments of this example, additionally or alternatively, the user may be presented with a user associated item such as directions on how to provide approval and/or authentication. In other embodiments of this example, additionally or alternatively, user associated items may include authentication items such as password, decryption key, user credentials, etc. Continuing with the example, authentication may be automatic, for instance by way of a remembered password or any other authentication item (where although for simplicity of description authentication is termed herein user authentication, in some cases the authentication additionally or alternatively includes authentication of recipient system 150). In another example, authentication is performed additionally or alternatively through user input, for instance a password or other authentication item.

Depending on the embodiment of stage 514, user item(s) and/or requirement(s) may be included in the data subset, may be included elsewhere in the data set, and/or may be known to intercepting replacer user checker 473 without being included in the data set, for example based on predetermined practice, retrieval from memory 456 and/or on-the-fly generation.

In the illustrated embodiments with optional stage 514, if user requirement(s) are not fulfilled (no to stage 514), then method 500 ends. Otherwise, if user requirement(s) are fulfilled in these embodiments (yes to stage 514), then method 300 continues with stage 516. In some other embodiments, stage 514 is omitted and there are no user requirements in order for method 500 to continue to stage 516.

In the illustrated embodiments, in stage 516, it is determined if data in the subset was transformed by data preparation system 110 and therefore inverse transformation of data in the subset is required. For example, in some implementations, inverse transformation may always be required or never be required. In another example, the beginning and/or end tag, file name/extension of an attachment which in a particular embodiment happens to be the data subset, and/or other data in the data subset, may specify whether or not inverse transformation should be performed and/or the type of inverse transformation.

If inverse transformation is required (yes to stage 516) then in the illustrated embodiments, in stage 520, intercepting replacer system 470, for example intercepting replacer inverse transformer 472, inverse transforms some or all of the data subset, in accordance with an inverse transformation which is typically the inverse of a transformation performed on the data by data preparation system 110. If inverse transformation is not required, then in the illustrated embodiments stage 520 is omitted.

In the illustrated embodiments, in stage 524, intercepting replacer system 470, for example, intercepting replacer data recognizer 479 determines if there are any pointers included in the data subset which should be used at this stage to fetch data from fetched data source 120. For example, the beginning and/or end tag, file name/extension of an attachment which in a particular embodiment happens to, be the data subset and/or other data in the data subset may specify whether or not such pointer(s) are included. As another example, intercepting replacer data recognizer 479 may be configured to recognize the format of such a pointer.

In some embodiments with included pointer(s), the data subset may include only pointer(s) (or only tag(s), pointer(s), validation requirement(s)/item(s), user requirement(s)/item(s), and/or notification(s), whereas in other embodiments the data subset may also include other data. Additionally or alternatively, in some embodiments with included pointer(s), a pointer may only be detected after inverse transformation, whereas in other embodiments a pointer may be detected without inverse transformation. Additionally or alternatively, in some embodiments with included pointer(s), the pointer is in a format which is recognizable to intercepting replacer data recognizer 479 as a pointer but not necessarily recognizable to other elements (for example channel security module(s) 134, recipient security module(s) 452, and/or intercepting replacer security module(s) 476) as a pointer. In some of these embodiments, the pointer is therefore not transformed by data preparation system 110 (and inverse transformed by intercepting replacer system 470). However in other of these embodiments the pointer may in any event have been transformed (and inverse transformed). Although not thus limited by the invention, in some eases, a pointer includes a URL or other location indication (which in some of these cases may have been previously transformed into a transformed URL or other location indication by data preparation system 110 and later inverse transformed).

If there are any pointers which should be used at this stage to fetch data from fetched data source 120 (yes to stage 524), then in the illustrated embodiments in stage 528, intercepting replacer system 470, for instance intercepting replacer communicator 474, uses the one or more pointers to fetch data from fetched data source 120. In some embodiments, the fetched data is transferred using the hypertext transfer protocol HTTP. In some embodiments, the fetched data includes at least one instruction that would not necessarily have been acceptable to channel security module(s) 134, recipient security module(s) 452 and/or intercepting replacer security module(s) 476 if the instruction(s) had been transferred as part of the data set, the fetched data includes at least one instruction which is not necessarily supported by all available receiving systems (for example not necessarily supported by receiving systems without intercepting replacer system 470), and/or the fetched data includes at least one transformed instruction. If there are no pointers which should be used at this stage to fetch data from fetched data source 120 (no to stage 524) then in the illustrated embodiments method 500 skips to stage 538.

In some embodiments there may be pointer(s) (transformed and/or untransformed) in the data subset or in the fetched data that intercepting replacer system 470 does not use to fetch data prior to completion of method 500. In these embodiments intercepting replacer system 470, for instance intercepting replacer data recognizer 479 may recognize such pointers for example based on a tag or other data, pointer format and/or separate indication. For example, in some embodiments of a message which originally included one or more attachments (e.g. image, document, etc), the content of the attachment(s) may be placed at fetched data source 120 or at another location (or fetched data source 120 or the other location may be capable of generating the content on the fly). In this example, the data subset or the fetched data may include pointer(s) which point to the content of the previously attached file(s) (or pointer(s) with generic reference to a current balance). In some of these embodiments, the pointers or a function thereof are presented as replacement data to the user via input/output 454 subsequent to the execution of method 500 so that the user can access the content of the previously attached file(s).

In the illustrated embodiments, in stage 532, it is determined if some or all of the fetched data was transformed by data preparation system 110 and/or by fetched data source 120 and therefore inverse transformation of the fetched data is required. For example, in some implementations, inverse transformation may always be required or never be required. Continuing with the example, assume the fetching in stage 528 was performed in a way which precludes filtering by channel security module(s) 134, for example using a cryptographic protocol such as SSL or for instance in embodiments where there are no recipient security module(s) 452 nor intercepting replacer security module(s) 452 using a communication channel other than channel 130 which does not include channel security module(s). Then in this example transformation and inverse transformation in order to avoid mishandling by security module(s) may not be required (although transformation and inverse transformation may in some cases still occur for other reasons). In another example, intercepting replacer system 470 may receive a separate indication from fetched data source 120 whether or not inverse transformation should be performed on that data, or may recognize from the fetched data whether or not inverse transformation should be performed for instance based on a tag or other data in the fetched data.

If inverse transformation is required (yes to stage 532) then in the illustrated embodiments, in stage 536, intercepting replacer system 470, for example intercepting replacer inverse transformer 472, inverse transforms some or all of the fetched data, in accordance with an inverse transformation which typically is the inverse of a transformation performed on the data by data preparation system 110 and/or fetched data source 120. If inverse transformation is not required, then in the illustrated embodiments stage 536 is omitted.

The invention does not limit the type of inverse transformation optionally performed by intercepting data replacer system 470 in stage 518 and/or 536. The inverse transformation may be any suitable inverse transformation which typically is the inverse of the transformation performed by data preparation system 110 and/or fetched data source 120. In some embodiments, the inverse transformation includes at least one of decrypting, decoding, decompressing, etc. In some embodiments, the inverse transformation recovers at least one instruction which in the recovered form would not necessarily have been to channel security module(s) 134, recipient security module(s) 452 and/or intercepting replacer security module(s) 476, and/or recovers at least one instruction which in the recovered form would not necessarily have been supported by all available receiving systems (for example not necessarily supported by receiving systems without intercepting replacer system 470).

In the illustrated embodiments in optional stage 538 intercepting replacer system 470, for instance intercepting replacer data adjuster 478 further adjusts some or all of the data originally in the data subset, and/or some or all of the fetched and/or inverse transformed data. The types of adjustment are not limited by the invention but for further illustration to the reader, some examples are now presented.

In one example, intercepting replacer data adjuster 478 stores in local memory 456 and/or in a remote memory (e.g. fetched data source 120 or another location) some or all of the data originally in the data subset, and/or some or all of the fetched and/or inverse transformed data. Intercepting replacer data adjuster 478 substitutes reference(s) for the stored data. In some cases of this example a reference may be associated with a “fake” pointer where the pointer is termed “fake” because the location indicated by the pointer is not the location where the data is stored. In other cases, the reference may be associated with a “real” pointer, where the location indicated is the location where the data is stored. In some of these cases, the pointer is identifiable as fake to intercepting replacer system 470, although not necessarily to post intercepting manager 460. The data to be stored may be recognized, for example by intercepting replacer data recognizer 479, based on a tag or other indicating data, format of the data to be stored, and/or separately received indication. The substitute reference(s) will be presented as replacement data to the user via input/output 454 subsequent to stage 540 so that the user can access the stored data. For instance, assume embodiments where the data set includes a message which previously had attached files (e.g. document(s), binary data such as image(s), etc). In these embodiments, the data originally in the data subset, and/or the fetched and/or inverse transformed data may include the content of the previously attached file(s) and/or the name(s) of previously attached file(s) with filename(s) and/or filename extension(s) identifiable as relating to attachment(s). In some of these embodiments the content of each previously attached file may be stored by intercepting replacer data adjuster 478 to local memory 456 or to a remote memory for later retrieval by the user, and a reference (for instance associated with a “fake” or real pointer) may be substituted for the attachment content and/or filename. Assuming embodiments where a reference is associated with a “fake” pointer, the “fake” pointer may in some of these embodiments be a dummy URL (or other dummy location indication) reference which is identifiable as being “fake” due to an incorporated string which indicates that the URL is a dummy URL, for instance www.gmail.com/dummy_attachment/document.xls?id=1, where “dummy_attachment” indicates that the URL is a dummy URL for the content of a previously attached file. Assuming embodiments where a reference is associated with a “real” pointer, the real pointer may in some of these embodiments be a real URL or other location indication to stored data.

In another example, additionally or alternatively, some or all of the data originally in the data subset, and/or some or all of the fetched and/or inverse transformed data may be converted to a different type by intercepting replacer data adjuster 478. For instance, XML data may be converted to HTML or vice versa.

In another example, additionally or alternatively, some or all of the data originally in the data subset, and/or some or all of the fetched and/or inverse transformed data may be removed by intercepting replacer data adjuster 478 because the data is unrelated to subsequent presentation of replacement data. For instance, in various embodiments any of the following may optionally be removed: data which affects the display or function of various reply buttons, data relating to content of a replied message, data relating to configuration settings or code for intercepting data replacer system 470, data relating to tag(s), data relating to validation requirement(s)/item(s) data relating to user requirement(s)/item(s), and/or data relating to notification(s), etc. In some cases, the removed data is separately handled by recipient system 150.

In another example, additionally or alternatively, data which was not included in the original data subset, nor in the fetched and/or inverse transformed data may be added by intercepting replacer data adjuster 478 because the data relates to subsequent presentation of replacement data. For instance in some cases of this example new notification(s) for the user are added. In some cases of this example, additionally or alternatively, the data added by intercepting data adjuster 478 ensures that when the replacement data is presented, it will be evident that the data is replacement data. For instance, in some of these cases intercepting data adjuster 478 may insert a table with a frame and/or to insert visual start and/or end (e.g. text, image or a combination) markers (e.g. using JavaScript or an Application Programming Interface API).

In the illustrated embodiments, in optional stage 540, filtering may be handled by intercepting data replacer system 470, for example by intercepting replacer security module(s) 476. Depending on the embodiment, the filtering may only be for the changes in the data subset due to inverse transformation, fetching, and/or adjustment or may also include filtering any remaining original data in the data subset (or alternatively may also include filtering any remaining original data in the data set). In embodiments with filtering, the filtering may or may not correspond to filtering performed by channel security module(s) 134 and/or recipient security module(s) 452, and/or may or may not correspond to any earlier filtering by intercepting replacer security module(s) 476. For example, in some of these embodiments, the filtering performed at stage 540 is less restrictive than filtering performed elsewhere and/or earlier. Continuing with the example, less restrictive may in some cases mean that some data which would have been unacceptable elsewhere and/or earlier is considered acceptable at stage 540, the threshold for acceptability is lower, and/or that data which includes unacceptable data is handled less strictly. Continuing with the example, in one of these embodiments the filtering in stage 540 may include dropping certain elements such as the object element (but not dropping scripts, images interactive fields/content, forms, pointers, and style elements) and scanning using an anti-virus scanner. Depending on the embodiment, the filtering policy may be customized per intercepting replacer system 470 or may be configured from some central location such as a server. Depending on the embodiment, replacer security module(s) 476 may handle filtering by performing the filtering or by other causing other security module(s) within recipient system 150, for example recipient security module(s) 452 to perform the filtering.

At this point, intercepting replacer system 470 has obtained data which corresponds to the data subset but which may or may not be identical to the data subset. For example, the corresponding data may be after adjustment and filtering, may include fetched data instead of pointer(s) which were included in the data subset, and/or may include inverse transformed data instead of transformed data, thereby differing from the data subset.

The invention does not limit how the corresponding data is integrated into the data set, however for further illustration to the reader, some examples will be provided. For example in some cases the corresponding data may be placed in an IFrame element in order to isolate the corresponding data from any other data in the data set, thereby precluding any clash between the corresponding data and the any other data, such as for example due to the same JavaScript function, variable names, etc. In another example, the corresponding data is not placed in an IFrame element but exists as a generic (e.g. DIV) element. In another example, the corresponding data (or the corresponding data in an IFrame element) is placed in a new window.

Subsequent to the execution of method 500, the corresponding data and any other data in the data set other than the data subset is processed for presentation by post intercepting manager 460, for example by post intercepting processing module 466. Part of the processing typically includes the execution of one or more instructions (if any) by post intercepting executor 468. Replacement data, which is presented instead of the data subset, is derived based on the corresponding data inter-alia through execution of one or more instructions (if any) included in the corresponding data. In some embodiments, the processing for presentation by post intercepting manager 460, for example by manager-replacer processing module 466, includes parsing the data set into a document object model or similar module. After processing for presentation, the data set is presented to the user via user input/output 454.

In embodiments where there are no instructions in the corresponding data, the replacement data is derived based on the corresponding data without execution of instructions, and in some cases of these embodiments the replacement data is substantially identical to the corresponding data.

In some embodiments, there is some indication to the user that replacement data is being presented instead of the data subset. For example, the replacement data may be presented in a manner which indicates that the data is replacement data, for instance the presentation may include a frame or visual markers optionally inserted by intercepting replacer data adjuster 478 as discussed above. Additionally or alternatively, in another example, a separate indication of the replacement may be provided to the user via user output 454.

In some embodiments, intercepting replacer system 470 provides some indication to data preparation system 110 and/or fetched data source 120 that replacement data was presented to the user instead of the data subset. For example, intercepting replacer communicator 474 can transfer such an indication to data preparation system 110 and/or fetched data source 120.

It is noted that the data presented to the user may in some cases include reference(s) associated with data stored in local memory 456 or in a remote memory, for example reference(s) created during stage 538 as discussed above. In such cases, intercepting data replacer system 470, for instance intercepting replacer data adjuster 478, determines that access to the stored data is desired. For example a user may have indicated a desire to access the data, for instance by clicking on the reference using input/output interface 454. As another example, additionally or alternatively, and assuming that the reference is associated with a “fake” or “real” pointer post-intercepting manager communicator 462 may have attempted to download data using the “fake” or “real” pointer. In these cases, intercepting data replacer system 470, may allow retrieval of the data from local memory 456 or a remote memory, for example by presenting a dialog for “saving” or “opening” the data to the user via user input/output 454. As mentioned above, in some cases the reference(s) may be associated with the content of previously attached files(s) to a message.

When referring below to “user input/output” without further designation or reference numeral, the term should be construed to refer to user input/output 254, user input/output 454 or any combination of the above. When referring below to “memory” without further designation or reference numeral, the term should be construed to refer to memory 256, memory 456, a remote memory, or any combination of the above. When referring below to “manager” without further designation or reference numeral, the term should be construed to refer to manager 260, post-intercepting manager 460, or any combination of the above. When referring below to “replacer system” or “data replacer system”, the term should be construed to refer to data replacer system 270 or intercepting replacer system 470 or any combination of the above.

When referring below to “obtainer” without further designation or reference numeral, the term should be construed to refer to replacer obtainer 275 intercepting replacer obtainer 475, or any combination of the above. When referring below to “processing module” without further designation or reference numeral, the term should be construed to refer to manager processing module 266, post intercepting processing module 466, or any combination of the above. When referring below to “inverse transformer” without further designation or reference numeral, the term should be construed to refer to replacer inverse transformer 272 or intercepting replacer inverse transformer 472, or any combination of the above. When referring below to “validator” without further designation or reference numeral, the term should be construed to refer to replacer validator 277, intercepting replacer validator 477, or any combination of the above. When referring below to “user checker”, without further designation or reference numeral, the term should be construed to refer to replacer user checker 273, intercepting replacer user checker 473 or any combination of the above. When referring below to “data recognizer” without further designation or reference numeral, the term should be construed to refer to replacer data recognizer 279, intercepting replacer data recognizer 479, or any combination of the above. When referring below to “data adjuster” without further designation or reference numeral, the term should be construed to refer to replacer data adjuster 278, intercepting replacer data adjuster 478, or any combination of the above.

When referring below to “communicator” without further designation or reference numeral, the term should be construed to refer to manager communicator 262, replacer communicator 274, intercepting replacer communicator 474, post intercepting manager communicator 462, or any combination of the above. Similarly, when referring below to “security module(s)”, without further designation or reference numeral, the term should be construed to refer to manager security module(s) 264, replacer security module(s) 276, channel security module(s) 134, intercepting replacer security module(s) 476, security module(s) 154, recipient security module(s) 252, recipient security module(s) 452, or any combination of the above. Similarly, when referring below to “executor”, without further designation or reference numeral, the term should be construed to refer to manager executor 268, replacer executor 290, post intercepting executor 468, or any combination of the above.

It is noted that in some embodiments of the aspect of the invention described with reference to FIGS. 2 and 3 and in some embodiments of the aspect of the invention described with reference to FIGS. 4 and 5 there is an obtaining of data which corresponds to a subset of received data. In these embodiments the corresponding data includes one or more instructions. In these embodiments there is a derivation of replacement data by executing one or more of the instructions, with the replacement data presented to the user instead of the data subset. In some of these embodiments, the data subset was transferred via channel 130 in a form which excludes any data which could possibly be unacceptable to security module(s) and/or which could possibly be unsupported by an available receiving system which could potentially be used by a user to receive the data (for example an available receiving system without replacer system 270 or intercepting replacer system 470).

It is also noted additionally or alternatively, that in some embodiments of the aspect of the invention described with reference to FIGS. 2 and 3 and in some embodiments of the aspect of the invention described with reference to FIGS. 4 and 5, there is an obtaining of data which corresponds to a subset of received data, where the corresponding data includes references to stored data, rather than the data itself.

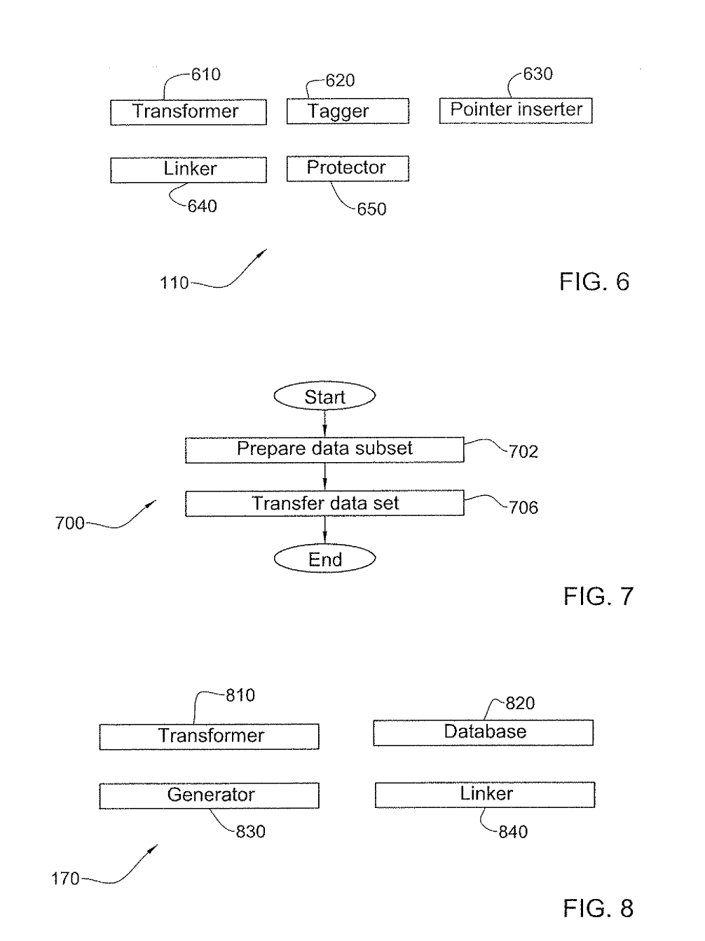

FIG. 6 is a block diagram of data preparation system 110 according to some embodiments of the invention. In the illustrated embodiments, data preparation system 110 includes any of the following: a transformer 610, a tagger 620, a pointer inserter 630, a linker 640, and/or a protector 650.

Each of the modules in data preparation system 110 may be made up of any combination of software, hardware and/or firmware capable of performing the operations as defined and explained herein. In some embodiments, data preparation system 110 may comprise fewer, more, and/or different modules than those shown in FIG. 6. In some embodiments, the functionality of data preparation system 110 described herein may be divided differently among the modules of FIG. 6. In some embodiments, the functionality of data preparation system 110 described herein may be divided into fewer, more and/or different modules than shown in FIG. 6 and/or data preparation system 110 may include additional, less and/or different functionality than described herein. Depending on the embodiment, modules in data preparation system 110 may be concentrated in one unit or separated among two or more units.

The invention does not limit the type of data preparation system 110 but for the sake of further illustration to the reader some examples are now provided. In some embodiments, data preparation system 110 may be or may be included in any of the following: web browser, email program, instant messaging client, other interne client, user interface, peer to peer application, SMS application plug in/add on programs that add functionality to an application, a stand along application, an applet, toolbar, a gateway, a proxy server, any other type of server, and/or any other element servicing multiple user devices etc.

FIG. 7 is a flowchart of a data preparation method 700 according to some embodiments of the invention. Method 700 is performed by data preparation system 110. In some cases, method 700 may include fewer, more and/or different stages than illustrated in FIG. 7, the stages may be executed in a different order than shown in FIG. 7, and/or stages that are illustrated as being executed sequentially may be executed in parallel.

For simplicity of description, the description below refers to a data group which includes a data subgroup from which a data subset will be prepared. The description further refers to a data set which includes the prepared data subset and optionally any other part of the data group which was not in the data subgroup. In the illustrated embodiments in stage 702, data preparation system 110 prepares the data subset. In some embodiments the preparation ensures that the data subset is in the form of plain text, in the form of HTML (excluding elements which may possibly be unacceptable to security module(s) and/or unsupported by potential receiving system(s)), or any other suitable form.

In some embodiments of stage 702, tagger 620 may determine if a data subset should be prepared from a data subgroup in a given data group. The determination may be based on tagger 620 recognizing that the data group includes one or more instructions, one or more instructions of predefined type(s) and/or one or more instructions that may potentially be unacceptable to security module(s) and/or may potentially be unsupported by a receiving system. If the determination is positive, then in some of these embodiments, a subset of data is prepared for transfer in place of a data subgroup which included the instruction(s), the instruction(s) of predefined type(s) and/or the instruction(s) that may be unacceptable and/or unsupported (and optionally also other data).

For example, preparation can include transformation of data for instance by transformer 610, insertion of (non-transformed and/or transformed) pointer(s) pointing to fetched data source 120 or another location for instance by pointer inserter 630, insertion of tag(s) and/or notification(s) for instance by tagger 620, protecting the data set and/or data subset by protector 650, any other data preparation task(s), and/or any combination of the above.

In some embodiments with transformation by transformer 610, transformation may include in some cases encrypting data, encoding data, and/or compressing data. Depending on the embodiment transformation may include transforming instruction(s), transforming pointers, transforming the content and/or file name(s) of previously attached file(s), and/or transforming other data.

In some embodiments with data protection, protector 650 may protect the data set or data subset by creating validation requirements, validation items, user items, user requirements, and/or by otherwise protecting data. For instance, protector 650 may perform any of the following: create a message authentication code, create a digital signature, create a hash, create a certificate, add a specific location (e.g. URL) for validation, create a user password, credentials, and/or decryption key, add approval and/or authentication question/directions, etc.

In some embodiments with pointer insertion, pointer inserter 630 may replace data such as instructions, previously attached file(s), and/or other data with (transformed or untransformed) pointer(s). For example, the pointer(s) can be a generic reference to a current balance or can point to the new location(s) of the instructions, content of previously attached files, and/or other data. In some cases data preparation system 110, for example linker 640, may transfer the data which was replaced by the pointer(s) to the new location(s), for instance at fetched data source 120 or elsewhere. The transfer may be an internal transfer (for instance if data preparation system 110 and fetched data source 120 are in the same unit) or an external transfer via channel 130 or via a different communication channel. If an external transfer, then in some cases data may be transferred in a manner which precludes filtering by any channel security module(s) for example using a cryptographic protocol such as SSL, or using a communication channel without channel security module(s).

In some embodiments where the data subset will be transferred to recipient system 150 as an attachment, data preparation additionally or alternatively includes creating the attachment file.

In the illustrated embodiments in stage 706, data preparation system 110, for example linker 640, transfers the data set, including at least the prepared data subset, to recipient system 150 via channel 130.

Refer to FIG. 8 which is a block diagram of fetched data source 120 according to some embodiments of the invention. In the illustrated embodiments, fetched data source 120 includes any of the following: a transformer 810, a database 820, a generator 830, and/or a linker 840.

Each of the modules in fetched data source 120 may be made up of any combination of software, hardware and/or firmware capable of performing the operations as defined and explained herein. In some embodiments, fetched data source 120 may comprise fewer, more, and/or different modules than those shown in FIG. 8. In some embodiments, the functionality of fetched data source 120 described herein may be divided differently among the modules of FIG. 8. In some embodiments, the functionality of fetched data source 120 described herein may be divided into fewer, more and/or different modules than shown in FIG. 8 and/or fetched data source 120 may include additional, less, and/or different functionality than described herein. Depending on the embodiment, modules in fetched data source 120 may be concentrated in one unit or separated among two or more units.

In some embodiments where fetched data source 120 includes database 820, the transferred data is received by linker 840 and the received data (or a transformed version) is stored in database 820. In some of these embodiments, recipient system 150 may use pointer(s) to fetch data stored in one or more entries in the database with each pointer containing a unique reference to a database entry.

Additionally or alternatively, in some embodiments where fetched data source 120 includes data generator 820, recipient system 150 uses pointer(s) with generic reference to a current balance, and data generator 820 generates on the fly or modifies the data which will be fetched by recipient system 150. For instance, the current balance may be generated and/or modified. In some cases of these embodiments, the generation or modification may vary depending on the configuration of recipient system 150, for optimal rendering by recipient system 150.

Additionally or alternatively, in some embodiments where there is data transformation, fetched data source 120 may include a transformer 810 for transforming data prior to storage and/or prior to transfer by linker 840 to recipient system 150. For example, in some cases transformer 810 may encrypt data, encode data, and/or compress data.

Therefore depending on the embodiment, the fetched data may not have undergone transformation, or may have undergone transformation at data preparation system 110 and/or at fetched data source 120.

In some embodiments where data transformation does not take place, linker 840 transfers fetched data to recipient system 150 in a manner which precludes filtering by any channel security module(s) for example using a cryptographic protocol such as SSL or using a communication channel without channel security module(s).

Although the form of the data set, the form of the data subset, and/or the form of substituted references are not limited by the invention, for the sake of further illustration to the reader some examples will now be given.

Some examples of a data set include inter-alia: a message [such as an email message (e.g. web-based or desktop email client based), SMS, social network message (e.g. Facebook message, Twitter “tweet”, etc) instant messaging message, etc], a webpage, etc.

Some examples of a data subset include inter-alia: a message (e.g. email, SMS, social network, instant message), part of a message, the body of a message, part of the body of a message, an attachment to a message, a webpage, part of a webpage, etc.

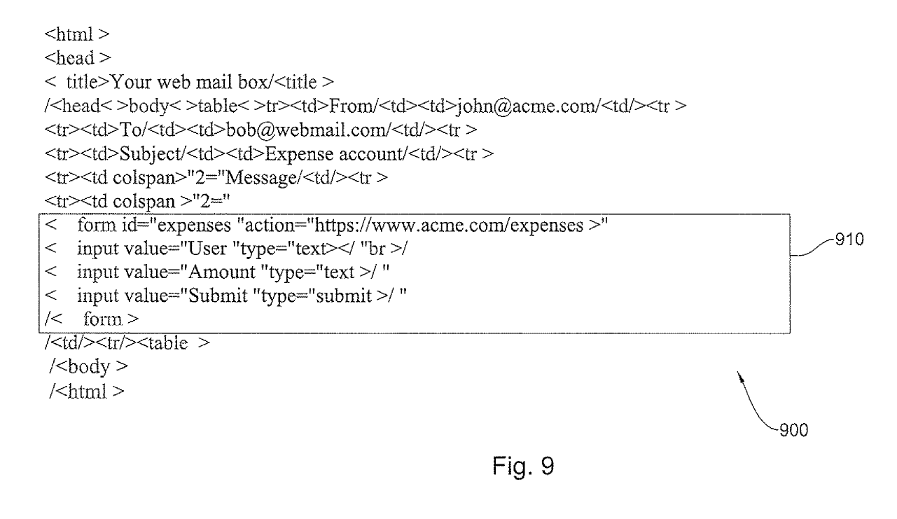

FIG. 9 illustrates an example of data group 900 prior to preparation of a data subset by data preparation system 110, according to some embodiments of the invention. In the illustrated embodiments of this example, data group 900 is a message which includes a data subgroup 910 from which the data subset will be prepared. It is noted that data subgroup 910 includes a “form” instruction which in some cases may be unacceptable to security module(s) if data group 900 were transferred as shown. For instance, in some cases, security module(s) would have removed the “form” instruction, would have deleted all of data group 900, would have classified data group 900 data as containing a potentially dangerous instruction, etc.

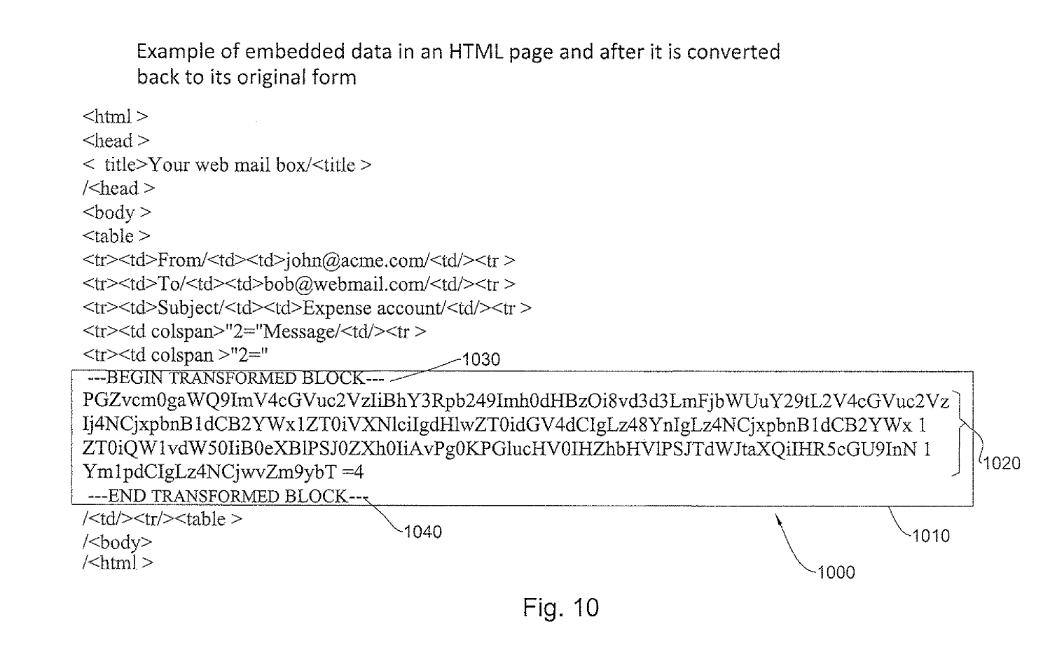

FIG. 10 illustrates an example of data set 1000 which includes the prepared data subset 1010, according to some embodiments of the invention. In the illustrated embodiments of this example data subset 1010 does not include any instructions. It is noted that data set 1000 is the same message as data group 900 except that data subset 1010 has been substituted for data subgroup 910. In the illustrated embodiments, data subset 1010 includes a transformation 1020 of data subgroup 910, a beginning tag 1030 and an end tag 1040. It is noted that in these embodiments, beginning tag 1030 and end tag 1040 specify that data subset 1010 includes transformed data.

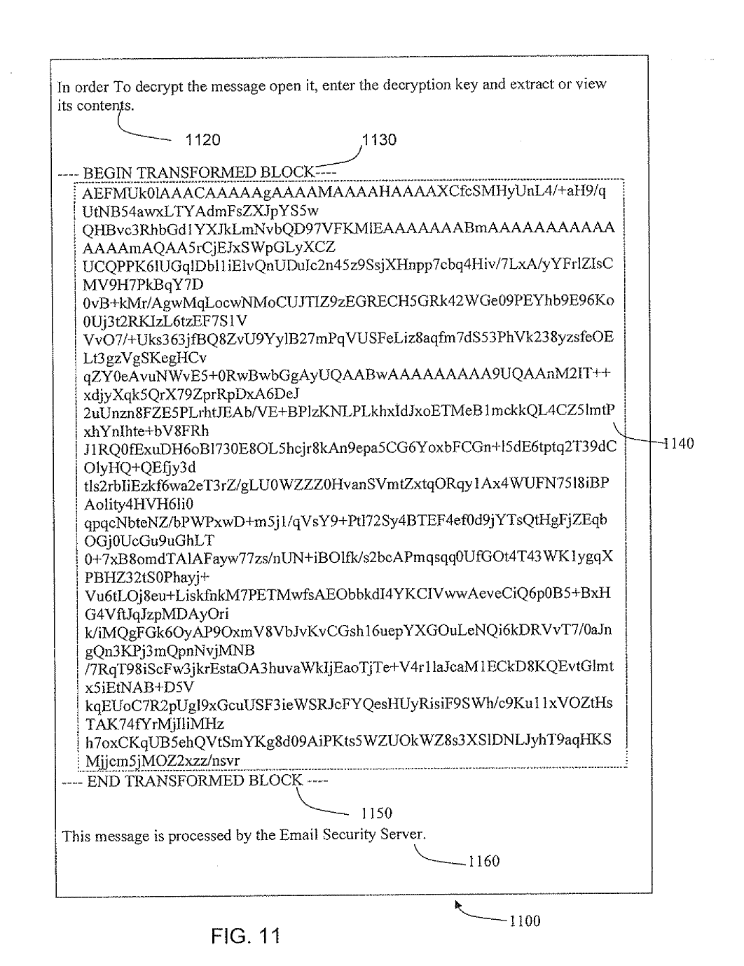

FIG. 11 illustrates another example of a prepared data subset 1100, according to some embodiments of the invention. In the illustrated embodiments of this example, data subset 1110 does not include any instructions. In these embodiments data subset 1110 includes user authentication directions 1120, transformed data 1140, tags 1130 and 1150, and a notification 1160. In this example tags 1130 and 1140 bound transformed data 1140 which may not otherwise be recognizable as being targeted for replacement.

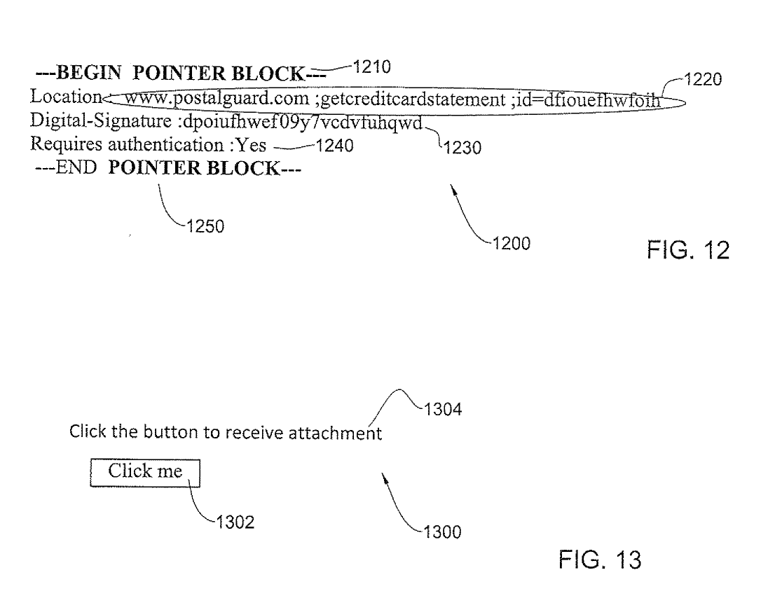

FIG. 12 illustrates another example of a prepared data subset 1200, according to some embodiments of the invention. In these embodiments, data subset 1200 includes a start tag 1210, a transformed pointer 1220 which in these embodiments is an encoded URL, a validation item 1230 which in these embodiments is a digital signature (shown in a concealed form), user authentication requirements 1240 which in these embodiments is positive (i.e. authentication is required), and an end tag 1250. It is noted that in the illustrated embodiments start tag 1210 and end tag 1250 specify that data subset 1200 includes a pointer.

FIG. 13 illustrates an example of displayed replacement data 1300 including a reference to stored data, according to some embodiments of the invention. In this example, the reference refers to stored content of a previously attached file and includes an interactive button 1302. The replacement data also includes a notification on how to retrieve the stored content of the previous attached file. For instance, the reference and notification may have been added during adjustment stage 338 or 538.

It will also be understood that in some embodiments a system or part of a system according to the invention may be a suitably programmed machine. Likewise, some embodiments of the invention contemplate a computer program being readable by a machine for executing a method of the invention. Some embodiments of the invention further contemplate a machine-readable memory tangibly embodying a program of instructions executable by the machine for executing a method of the invention. Examples of machine-readable memory include inter-alia any type of disk including floppy disk, hard disk, optical disk, CD-ROMs, magnetic-optical disk, magnetic tape, flash memory, random access memory (RAMs), dynamic random access memory (DRAM), static random access memory (SRAM), read-only memory (ROMs), programmable read only memory PROM, electrically programmable read-only memory (EPROMs), electrically erasable and programmable read only memory (EEPROMs), magnetic card, optical card, and/or any other type of media suitable for storing electronic instructions and capable of being coupled to a system bus.

While the invention has, been shown and described with respect to particular embodiments, it is not thus limited. Numerous modifications, changes and improvements within the scope of the invention will now occur to the reader.

1. A method of causing presentation of replacement data, comprising:
obtaining corresponding data which corresponds to a subset of a set of data, said set of data having been received via a communication channel and processed for presentation, said corresponding data including at least one instruction; and
triggering additional processing of said set of data, wherein said additional processing causes at least one of said at least one instruction to be executed in order to derive, based on said corresponding data, replacement data for presentation instead of said data subset.

2. The method of claim 1, wherein said data subset includes a pointer, and wherein said obtaining corresponding data includes:
using said pointer to obtain corresponding data.

3. The method of claim 1, wherein said data subset includes transformed data, and wherein said obtaining corresponding data includes:
inverse transforming said transformed data in order to obtain corresponding data.

4. The method of claim 3, wherein said inverse transforming includes at least one action selected from a group comprising decryption, decompression, or decoding.

5. The method of claim 1, wherein said data subset includes a pointer, and wherein said obtaining corresponding data includes:
using said pointer to receive data;
inverse transforming said received data in order to obtain corresponding data.

6. The method of claim 1, wherein said obtaining corresponding data includes at least one of the following: converting data, removing data, and/or adding data.

7. The method of claim 1, wherein said obtaining corresponding data includes:
substituting a reference for stored data.

8. The method of claim 1, wherein said obtaining corresponding data includes:
handling filtering so that corresponding data is filtered.

9. The method of claim 1, wherein said obtaining corresponding data includes:
validating at least one of said set or subset.

10. The method of claim 9, wherein said validating includes at least one action selected from a group comprising: checking internal integrity, checking a message authentication code, checking a digital signature, checking a certificate used for signing, or checking for a specific location for performing validation.

11. The method of claim 1, wherein said data subset was transferred in a form which excludes instructions.

12. The method of claim 11, wherein said form is plain text or HTML

13. The method of claim 1, wherein said data set is a message.

14. The method of claim 13, wherein said subset is selected from a group comprising: said message, part of said message, a body of said message, part of a body of said message, an attachment to said message.

15. The method of claim 1, wherein said triggering additional processing includes:
stripping said at least one of said at least one instruction from said corresponding data to derive stripped data;
inserting said stripped data; and
providing said stripped at least one instruction for execution on said stripped data.

16. The method of claim 1, wherein said triggering additional processing includes:
inserting an adapted IFrame element including said corresponding data.

17. The method of claim 16, wherein said inserting includes adjusting dimensions of said IFrame.

18. The method of claim 1, wherein said triggering additional processing includes:
inserting an object element, said object configured when invoked to execute said at least one of said at least one instruction.

19. A method of obtaining corresponding data; comprising
obtaining corresponding data which corresponds to a subset of a set of data, said set of data having been received via a communication channel, said received subset of data being in a form which is acceptable to at least one security module, but said corresponding data including at least one instruction which would not have been acceptable to at least one security module;
wherein replacement data is derived based on said corresponding data for presentation instead of said data subset by executing at least one of said at least one instruction.

20. The method of claim 19, wherein said data subset includes a pointer, and wherein said obtaining corresponding data includes:
using said pointer to obtain corresponding data.

21. The method of claim 19, wherein said data subset includes transformed data, and wherein said obtaining corresponding data includes:
inverse transforming said transformed data in order to obtain corresponding data.

22. The method of claim 21, wherein said inverse transforming includes at least one action selected from a group comprising decryption, decompression, or decoding.

23. The method of claim 19, wherein said data subset includes a pointer, and wherein said obtaining corresponding data includes:
using said pointer to receive data;
inverse transforming said received data in order to obtain corresponding data.

24. The method of claim 19, wherein said obtaining corresponding data includes at least one of the following: converting data, removing data, and/or adding data.

25. The method of claim 19, wherein said obtaining corresponding data includes:
substituting a reference for locally stored data.

26. The method of claim 19, wherein said obtaining corresponding data includes:
handling filtering so that corresponding data is filtered.

27. The method of claim 19, wherein said obtaining corresponding data includes:
validating at least one of said set or subset.

28. The method of claim 27, wherein said validating includes at least one action selected from a group comprising: checking internal integrity, checking a message authentication code, checking a digital signature, checking a certificate used for signing, or checking for a specific location for performing validation.

29. The method of claim 19, wherein said form is plain text or HTML.

30. The method of claim 19, wherein said data set is a message.

31. The method of claim 30, wherein said subset is selected from a group comprising: said message, part of said message, a body of said message, part of a body of said message, an attachment to said message.

32. A method of presenting to a user content of a file previously attached to a message, comprising:
receiving a message including transformed content of a previously attached file via a communication channel;
inverse transforming said transformed content to recover content of said previously attached file;
storing said recovered content;
substituting a reference in said message for said transformed content; and
when a user indicates desire to access said stored content, retrieving said content and presenting said content to said user.

33. The method of claim 32, wherein said received message also includes a transformed instruction which would have been unacceptable to a security module if it had been untransformed.

34. A method of causing presentation of replacement data, comprising:
preparing a subset of data;
transferring a set of data including said subset of data via a communication channel;
receiving said set of data;
processing said set of data for presentation;
obtaining corresponding data which corresponds to said subset, said corresponding data including at least one instruction; and
triggering additional processing of said set of data, wherein said additional processing causes at least one of said at least one instruction, to be executed in order to derive, based on said corresponding data, replacement data for presentation instead of said data subset.

35. A method of obtaining corresponding data; comprising:
preparing a subset of data;
transferring said set of data including said subset of data via a communication channel, wherein said subset is transferred in a form which is acceptable to at least one security module;
receiving said set of data;
obtaining corresponding data which corresponds to said subset, said corresponding data including at least one instruction which would not have been acceptable to at least one security module; and
deriving replacement data based on said corresponding data for presentation instead of said data subset by executing at least one of said at least one instruction.

36. A method of presenting to a user content of a file previously attached to a message, comprising:
removing a file attached to a message;
transforming content of said file;
including said transformed content in said message;
transferring said message via a communication channel;
receiving said message;
inverse transforming said transformed content to recover content of said previously attached file;
storing said recovered content;
substituting a reference in said message for said transformed content; and
when a user indicates desire to access said stored content, retrieving said content and presenting said content to said user.

37. A system for causing presentation of replacement data, comprising:
an obtainer operable to obtain corresponding data which corresponds to a subset of a set of data, said set of data having been received via a communication channel and processed for presentation, said corresponding data including at least one instruction; and
a trigger activator operable to trigger additional processing of said set of data, wherein said additional processing causes at least one of said at least one instruction to be executed in order to derive, based on said corresponding data, replacement data for presentation instead of said data subset.

38. The system of claim 37, wherein said system is an applet, toolbar, plug in or add-on to one of the following: email client, web browser, SMS application, instant messaging client, user interface, peer to peer application, another type of Internet client, gateway, proxy server, another type of server, or another element servicing multiple user devices.

39. The system of claim 37, wherein said system is a standalone element.

40. The system of claim 37, wherein said system is an email client, web browser, SMS application, instant messaging client, user interface, peer to peer application, another type of Internet client, gateway, proxy server, or another type of server.

41. A system for obtaining corresponding data; comprising:
an obtainer operable to obtain corresponding data which corresponds to a subset of a set of data, said set of data having been received via a communication channel, said received subset of data being in a form which is acceptable to at least one security module, but said corresponding data including at least one instruction which would not have been acceptable to at least one security module;
wherein replacement data is derived based on said corresponding data for presentation instead of said data subset by executing at least one of said at least one instruction.

42. The system of claim 41, wherein said system is an applet, toolbar, plug in or add-on to one of the following: email client, web browser, SMS application, instant messaging client, user interface, peer to peer application, another type of Internet client, gateway, proxy server, another type of server, or another element servicing multiple user devices.

43. The system of claim 41, wherein said system is a standalone element.

44. The system of claim 41, wherein said system is an email client, web browser, SMS application, instant messaging client, user interface, peer to peer application, another type of Internet client, gateway, proxy server, or another type of server.

45. A system for presenting to a user content of a file previously attached to a message, comprising:
a communicator operable to receive a message including transformed content of a previously attached file via a communication channel;
an inverse transformer operable to inverse transform said transformed content to recover content of said previously attached file; and
a data adjuster operable to store said recovered content, operable to substitute a reference for said transformed content, and when a user indicates desire to access said stored content, operable to retrieve said content and present said content to said user.

46. The system of claim 45, wherein said system is an applet, toolbar, plug in or add-on to one of the following: email client, web browser, SMS application, instant messaging client, user interface, peer to peer application, another type of Internet client, gateway, proxy server, another type of server, or another element servicing multiple user devices.

47. The system of claim 45, wherein said system is a standalone element.

48. The system of claim 45, wherein said system is an email client, web browser, SMS application, instant messaging client, user interface, peer to peer application, another type of Internet client, gateway, proxy server, or another type of server.

49. A computer program product comprising a computer useable medium having computer readable program code embodied therein for causing presentation of replacement data, the computer program product comprising:
computer readable program code for causing the computer to obtain corresponding data which corresponds to a subset of a set of data, said set of data having been received via a communication channel and processed for presentation, said corresponding data including at least one instruction; and
computer readable program code for causing the computer to trigger additional processing of said set of data, wherein said additional processing causes at least one of said at least one instruction to be executed in order to derive, based on said corresponding data, replacement data for presentation instead of said data subset.

50. A computer program product comprising a computer useable medium having computer readable program code embodied therein for obtaining corresponding data; the computer program product comprising:
computer readable program code for causing the computer to obtain corresponding data which corresponds to a subset of a set of data, said set of data having been received via a communication channel, said received subset of data being in a form which is acceptable to at least one security module, but said corresponding data including at least one instruction which would not have been acceptable to at least one security module;
wherein replacement data is derived based on said corresponding data for presentation instead of said data subset by executing at least one of said at least one instruction.

51. A computer program product comprising a computer useable medium having computer readable program code embodied therein for presenting to a user content of a file previously attached to a message, the computer program product comprising:
computer readable program code for causing the computer to receive a message including transformed content of a previously attached file via a communication channel;
computer readable program code for causing the computer to inverse transform said transformed content to recover content of said previously attached file;
computer readable program code for causing the computer to store said recovered content;
computer readable program code for causing the computer to substitute a reference in said message for said transformed content; and
computer readable program code for causing the computer to retrieve said content and present said content to said user when a user indicates desire to access said stored content.
